(19) United States
(12) Patent Application Publication
(10) Pub. No.: US 2011/0313580 A1
(43) Pub. Date: Dec. 22, 2011

(54) METHOD AND PLATFORM TO IMPLEMENT SAFETY CRITICAL SYSTEMS

(76) Inventor: Levgenii Bakhmach, Kirovograd (UA)

(21) Appl. No.: 12/817,862

(22) Filed: Jun. 17, 2010

(51) Int. Cl. G06F 1/28; G05B 9/02

(52) U.S. Cl. 700/292; 700/79; 700/21

(57) ABSTRACT

A method of monitoring and controlling plant operations, which receive input signals from sensors monitoring parameters of plant operation to generate output signals to actuators, comprising; reducing the input signals to a selected group of input functions; reducing the output signals to a selected group of output functions; processing the input signals using FPGA to generate the output signals. The invention also relates to the platform and system embodying the method.

### FIELD OF THE INVENTION

The present invention relates to automation devices. More particularly, the present invention is in the technical field of digital equipment of automated control systems of technological processes and safety control systems and methods relating thereto.

### BACKGROUND TO THE INVENTION

There are many areas where safety critical systems are found. Safety critical systems are computer (digital), electronic or electromechanical systems whose failure may cause injury or death to human beings, environmental harm, loss or severe damage to equipment. For example chemicals plant or nuclear power stations control systems. Usually such safety critical systems measure a multitude of parameters related to the plant or facility (e.g. temperature, pressure, flow rates and neutron flux density), monitor various components (e.g. valves, pumps, generators and control devises) and perform control functions (e.g. send signals to actuators, initiate a reactor trip, or the like).

For reliability as well as improvement in safety, such safety critical systems utilize different types of redundancy and diversity techniques. For example, most existing nuclear power plant protection systems have at least two parallel channels each of which includes several tracks (subsystems or logic circuits) and voting schemes.

One such system is shown in U.S. Pat. No. 6,484,126 which relates to a system and method for interfacing with a nuclear power plant's digital plant protection system activates emergency response devices when necessary. Two redundant bistable processors in each of four logic channels determine whether a particular parameter of the plant operation exceeds safety limits based on output from the plant protection system which monitors plant operations. Two independent coincidence processors in each channel compare the output of each bistable processor with the complementary output of a bistable processor of another logic channel. The results are provided to a series of component control system processors for activating emergency response devices when necessary. A fiber optic network interconnects the logic channels. Within each channel, a fiber optic network is provided between the component control system processors and a main control room so that a manual activation signal can be sent to the component control processors

Another example is shown in U.S. Pat. No. 5,227,121, which teaches a control room complex for a nuclear power plant, including a discrete indicator and alarm for response to changes in plant parameters and a component control system which together provide a discrete monitoring and control capability at a panel in a control room. A separate data processing system provides integrated and overview information to the control room and to each panel, through CRTs and a large, overhead integrated process status overview board. The discrete indicator and alarm system and the data processing system receive inputs from common plant sensors and validate the sensor outputs to arrive at a representative value of the parameter for use by the operator during both normal and accident conditions, thereby avoiding the need to assimilate data from each sensor individually.

Yet another arrangement is shown in U.S. Pat. No. 6,292,523 which relates to an interface between a Plant Protection System and Engineered Safety Features in a nuclear power plant for continuously monitoring the plant protection system initiation circuit for each remotely actuated Engineered Safety Feature system to effect remedial action in the event that the Plant Protection System generates a ‘trip’ signal. By using actuation inputs from the Plant Protection System and manual, operator implemented inputs, controls are provided for remote equipment components, such as solenoid valves, motor operated valves, pumps, fans and dampers.

Finally U.S. Pat. No. 7,512,917 shows a verification method for verifying a safety apparatus including a programmable logic device having a plurality of functional elements. The verification method includes the steps of exhaustively verifying the plurality of functional elements on actual hardware, generating a functional element that is the same as one of the functional elements verified on the actual apparatus using a predetermined hardware description language, independently logic-synthesizing each generated functional element into a plurality of first net lists, generating a connection function between the functional elements using the predetermined hardware description language, logic-synthesizing the generated connection function into a second net list corresponding to the connection function, synthesizing the first net lists with the second net list to generate a third net list, writing a logic circuit into the programmable logic device on the basis of the third net list, and verifying the actual programmable logic device.

Still other systems are described in UA 2468 published April 2004, UA 22172 published in April 2007 and UA 78477 published in March 2007.

There is a need for an improved safety critical system and method relating thereto.

Typically improvements to reliability of such safety critical systems result in growing system complexity and cost. Additionally, designs uniqueness and function specificity of safety critical systems require a significant amount of time for design, development and verification, that results in high project costs.

On the other hand the list of important characteristics of a plant for particular applications has almost remained unchanged over the years. Therefore the types of input and output signals of any safety critical systems in this application domain form a stationary set of signal types. That in turn forms the basis for unification of functions and reuse components of safety critical systems.

### SUMMARY OF THE INVENTION

It is an object of the present invention to provide a method for implementing a safety critical system, based on reducing the myriad of monitoring and control functions into basic groups of functions and their implementation with Field Programmable Gate Arrays (FPGA) and optionally to configure different redundant systems.

It is a further object of the present invention to provide a platform that includes a set of FPGA-based functional modules. The functions that are provided by a module correspond with functions in a group. Therefore the number of groups of functions in a method is equal to the number of functional modules in platform.

The present invention also encompasses variants of safety critical systems configured according to the method with modules of platform. Represented Reactor Trip Systems and Engineering Safety Features Actuation Systems comprise modules of platform. The present invention is not limited by these systems, rather its main aim is implementation of different safety critical systems, based on the platform.

Thus, a primary object of this invention is to provide a method for implementing safety critical systems through configuring required system functionality out of the functions of platforms' modules.

It is an aspect of this invention to provide a method of monitoring and controlling plant operations, which receive input signals from sensors monitoring parameters of plant operation to generate output signals to actuators, comprising; reducing the input signals to a selected group of input functions; reducing the output signals to a selected group of output functions; processing the input signals using FPGA to generate the output signals.

It is another aspect of this invention to provide a method to implement safety critical systems, to perform monitoring and control functions, comprising: receiving information on the controlled parameters of sensors and other instrumentation and control (I&C) systems, processing this information and sending control and informational signals to actuators and other l&C systems; according to technological algorithms; reducing the I&C functions into groups of functions according to:
input current and voltage signals processing;
input signals from thermocouples and resistive temperature detectors processing;
input signals from neutron flux detectors processing;
input dry contact discrete signals processing;
input potential discrete signals of direct voltage and/or alternating voltage processing;
plant state monitoring based on received information and sending control and informational signals to actuators and l&C systems according to technological algorithms;
output current and voltage signals forming;
output potential and dry contact discrete signals forming;
actuators control;
system diagnostics;
electric and optic communication between the system components;
implementing of the group of functions using Field Programmable Gate Arrays (FPGA); and implementing said group of functions within one track or within many redundant tracks.

Yet another aspect of this invention relates to a platform for monitoring and controlling plant operations, which receive input signals from sensors monitoring parameters of plant operation to generate output signals to actuators; which includes the following set of functional modules: Analog Information Input Module; Temperature Information Input Module; Neutron Flux Information Input Module; Discrete Information Input Module; Potential Signals Input Module; Logic Module that has an FPGA electronic design; Analog Information Output Module; Discrete Information Output Module; Actuators Control Module; Diagnostic Module; Optic Communication Module.

A further aspect of this invention relates to a Reactor Trip System, which performs the following functions: storage of setpoints and conditions of reactor trip initiation; automatic monitoring of technological parameters and equipment states; forming of reactor trip signals in case of breaking of set points and conditions; data exchange with I&C systems of reactor; indication of technological parameters, reactor trip information and alarm signals at Main Control Room and Emergency Control Room; data archiving, registration and visualization; self-diagnostic and visualization of diagnostic data; has four or three tracks; and includes Signal Forming Cabinets (SFC) comprising the following platform modules (one or several of each type) namely: Analog Information Input Module; Temperature Information Input Module; Neutron Flux Information Input Module; Discrete Information Input Module; Potential Signals Input Module; Logic Module; Discrete Information Output Module; Diagnostic Module; Optic Communication Module; includes Cross Output Cabinet (COC) comprising the following platform modules (one or several of each type): Logic Module; Analog Information Output Module; Discrete Information Output Module; Diagnostic Module; Optic Communication Module.

Yet another aspect of this invention relates to a reactor trip system as described herein.

Other objects and features of the invention will be seen from detailed description and the accompanying drawing

### BRIEF DESCRIPTION OF THE DRAWINGS

FIG. 1 is a block diagram of redundant system with three tracks and voting logic “2-out-of-3”.

FIG. 2 is a block diagram of redundant system with three tracks, three elements of voting logic “2-out-of-3” and logic element OR (“1-out-of-3” voting).

FIG. 3 is a block diagram of redundant system with four tracks and voting logic “2-out-of-4”.

FIG. 4 is a block diagram of redundant system with four tracks, four elements of voting logic “2-out-of-4” and logic element OR (“1-out-of-4” voting).

FIG. 5 is a block diagram of two-version redundant system with N tracks, voting logic “M-out-of-N” for outputs of tracks and logic OR (“1-out-of-2” voting) for outputs of channels. Versions are located in different cabinets.

FIG. 6 is a block diagram of two-version redundant system with N tracks, voting logic “M-out-of-N” for each track and logic OR for outputs. Versions are located in different cabinets.

FIG. 7 is a block diagram of two-version redundant system with N tracks, voting logic “M-out-of-N” for outputs of tracks and logic OR for outputs of channels. Versions (diverse tracks from different channels) are located in one cabinet.

FIG. 8 is a block diagram of two-version redundant system with N tracks, voting logic “M-out-of-N” for each track and logic OR for outputs. Versions (diverse tracks from different channels) are located in one cabinet.

FIG. 9 is a block diagram of N-version redundant system with N tracks and voting logic “M-out-of-N” for outputs.

FIG. 10 is a block diagram of N-version redundant system with N tracks, voting logic “M-out-of-N” for each track and logic OR (“1-out-of-N” voting) for outputs.

FIG. 11 is a block diagram of redundant system with N two-version tracks, voting logic OR (“1-out-of-2” voting) for versions in each track and logic “M-out-of-N” for outputs.

FIG. 12 is a block diagram of two-channel redundant system with two-version tracks in primary channel and one-version tracks in diverse channel.

FIG. 13 is a block diagram of two-channel redundant system with two-version tracks in both channels.

FIG. 14 is a block diagram of platform including eleven functional modules.

FIG. 15 is a simplified functional block diagram of Analog Information Input Module.

FIG. 16 is a simplified functional block diagram of Temperature Information Input Module.

FIG. 17 is a simplified functional block diagram of Neutron Flux Information Input Module.

FIG. 18 is a simplified functional block diagram of Discrete Information Input Module.

FIG. 19 is a simplified functional block diagram of Potential Signals Input Module.

FIG. 20 is a simplified functional block diagram of Logic Module.

FIG. 21 is a simplified functional block diagram of Analog Information Output Module.

FIG. 22 is a simplified functional block diagram of Discrete Information Output Module.

FIG. 23 is a simplified functional block diagram of Actuators Control Module.

FIG. 24 is a simplified functional block diagram of Diagnostic Module.

FIG. 25 is a simplified functional block diagram of Optic Communication Module.

FIG. 26 is a block diagram of Reactor Trip System with one three-track channel.

FIG. 27 is a block diagram of Reactor Trip System with one four-track channel.

FIG. 28 is a block diagram of Reactor Trip System with two three-track channels.

FIG. 29 is a block diagram of Reactor Trip System with two four-track channels.

FIG. 30 is a block diagram of Engineering Safety Features Actuation System with one three-track channel.

FIG. 31 is a block diagram of Engineering Safety Features Actuation System with one four-track

### DETAILED DESCRIPTION OF THE INVENTION

Safety critical systems, designed to perform monitoring and control functions, have to provide receiving information on the controlled parameters of sensors and other instrumentation and control (I&C) systems, processing this information and sending control and informational signals to actuators and other I&C systems according to technological algorithms.

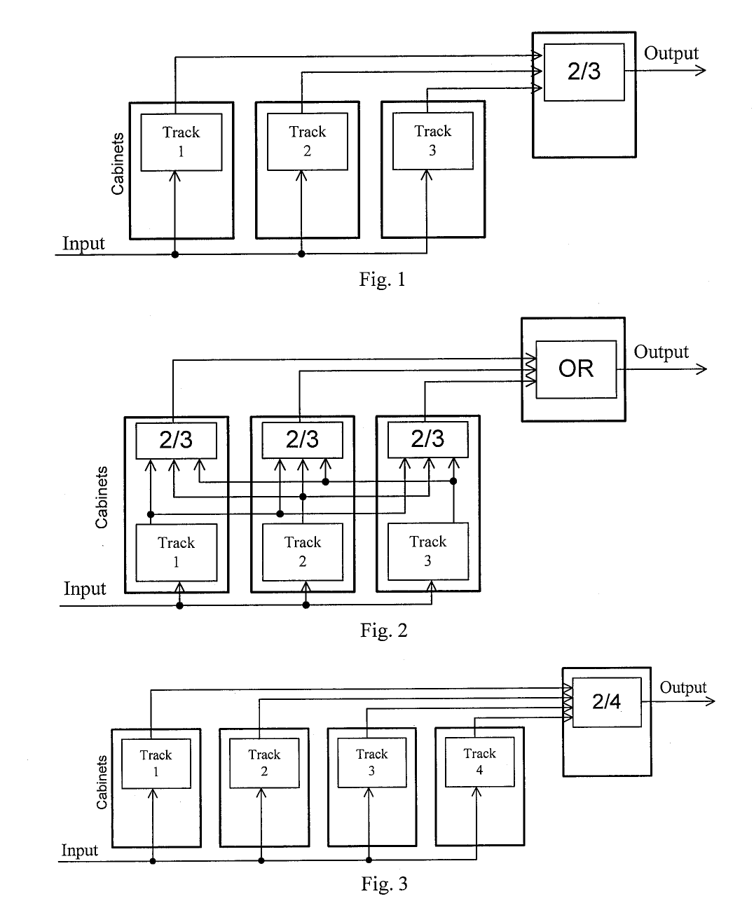

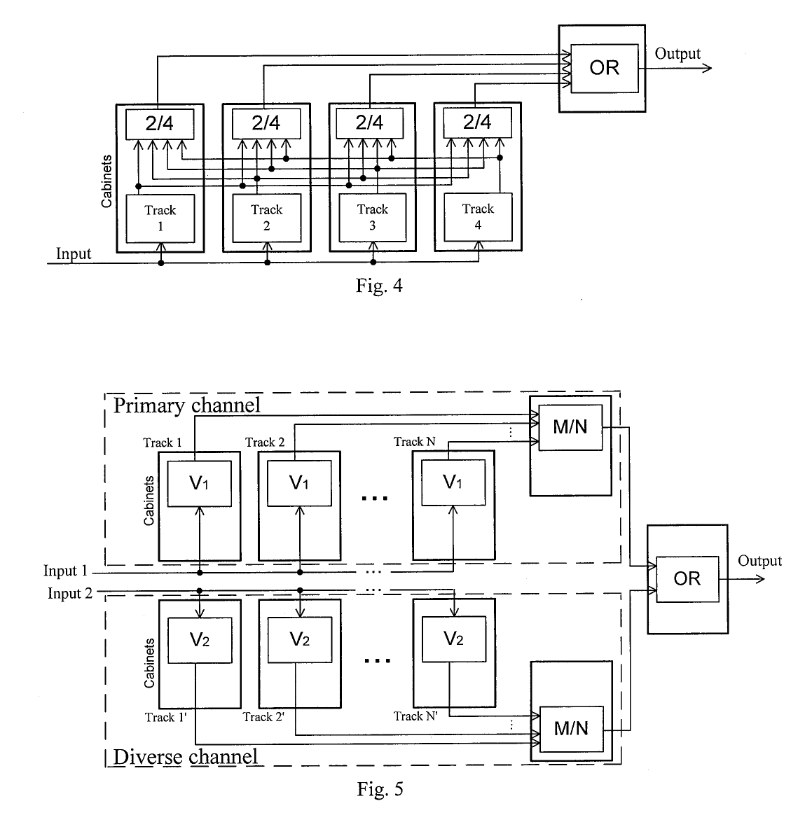

Redundancy is used to improve reliability in safety critical systems. Examples of redundant systems with three tracks are shown in FIG. 1 and FIG. 2. FIG. 3 and FIG. 4 show examples of four-track redundant systems.

More specifically FIG. 1 shows an input from a sensor, which could for example consist of a low voltage. There are 3 cabinets shown, each of which have a separate Track 1, 2, and 3; that is each path has there own logic circuits. Each of the Tracks 1,2 and 3 or paths monitor the signals with a voting system as shown in FIG. 1 ie 2/3. In other words so long as 2 out of the three Tracks monitor a desired condition, the parameter being read by the sensor shows that the desired condition is operating as designed. Even if one of the Tracks monitors a condition that is not desired the other two Tracks produce an output as shown in FIG. 1, all in a manner that is known to those persons skilled in the art. This takes into account that there may be old sensors or circuits that malfunction or give a false reading. Each of the Track 1, 2 and 3 include a Field Programmable Gate Array (FPGA) to be described herein.

FIG. 2 shows another redundant system where every one of the Tracks 1, 2, and 3 uses the majority principle as shown. FIGS. 3 and 4 illustrate 4 Track systems that are similar to those shown in FIGS. 1 and 2 respectively.

Additionally, in redundant safety critical systems different diverse techniques can be used as a means against common mode failure. In that case different versions V of tracks are used in parallel channels. The channels differ in one or several diversity types.

FIG. 5 shows a block diagram for two-version systems V₁ and V₂ that consist of primary and diverse channels comprising N tracks (usually three or four) located in different cabinets with voting logic implemented in a separate cabinet. For outputs of channels the voting logic “1-out-of-2” (logic OR) is used. For example the difference in diversity or versions V₁ and V₂ can be as a result of different software for the FPGA's to be described herein, or different hardware in the circuits, or different people developing different channels. In other words the same results can be accomplished in different ways, so as to add to the redundancy of the system.

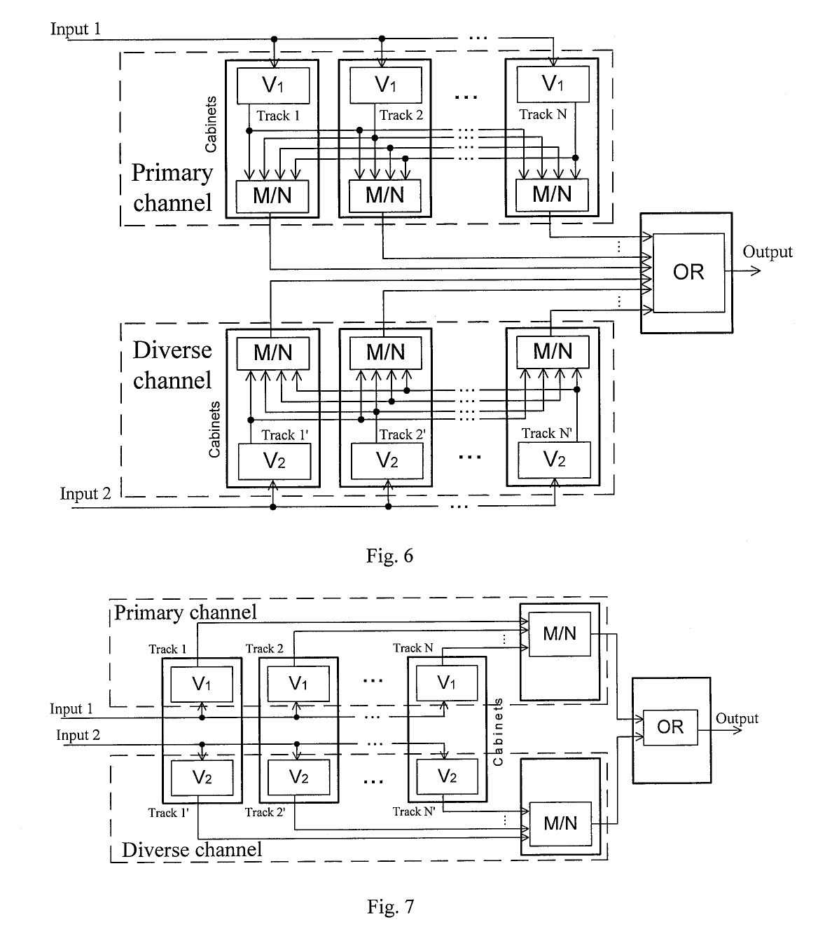

FIG. 6 shows a block diagram for two-version systems V₁ and V₂ that consist of primary and diverse channels comprising N tracks (usually three or four) located in different cabinets with voting logic implemented for each track (so long as M results out of N Tracks) in the same cabinet. For outputs of channels the logic OR is used.

FIG. 7 shows a block diagram for two-version systems V₁ and V₂ that consist of primary and diverse channels comprising N couples of tracks located in different cabinets with voting logic implemented in a separate cabinet. For outputs of channels the logic OR is used.

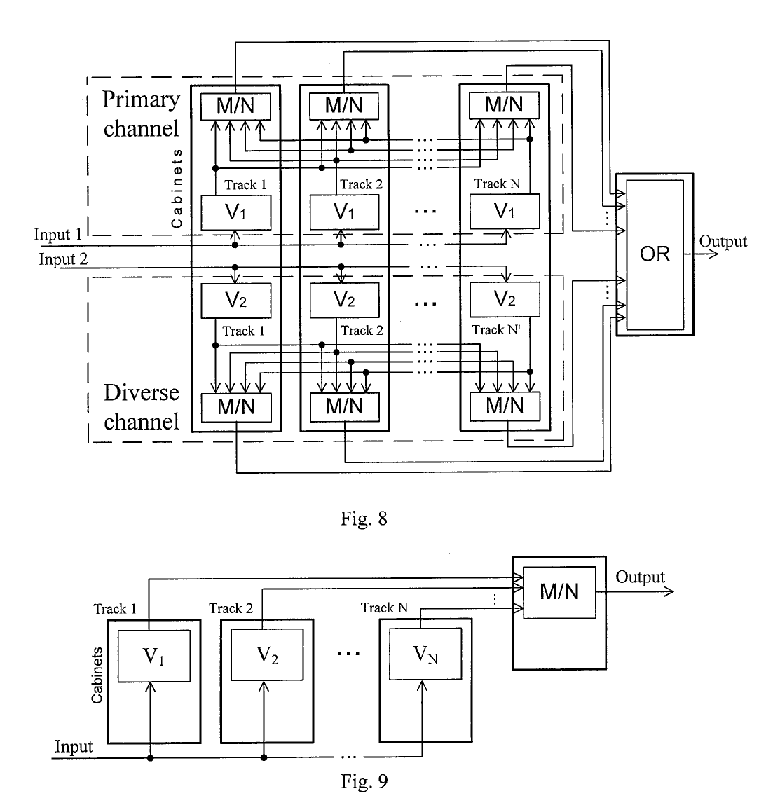

FIG. 8 shows a block diagram for two-version systems V₁ and V₂ that consist of primary and diverse channels comprising N couples of tracks located in different cabinets with voting logic implemented for each track in the same cabinet. For outputs of channels the logic OR is used.

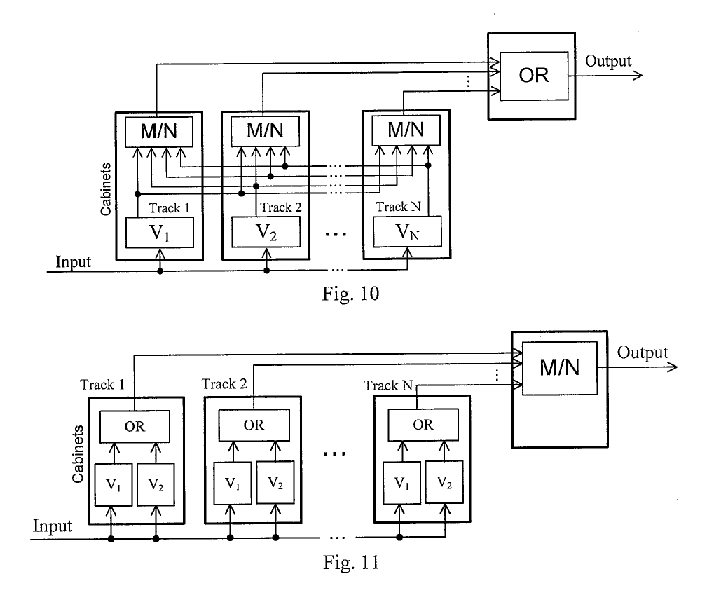

Diversity can also be implemented within a track. Each track can be implemented individually and system with N tracks comprises N diverse versions (FIG. 9 and FIG. 10).

A variant with internal diversity for tracks, each of which has two versions with logic OR and form signal for output voting logic “M-out-of-N”, is also possible (FIG. 11). Such systems may be useful if there is an error in the chip that may not be detected into the future.

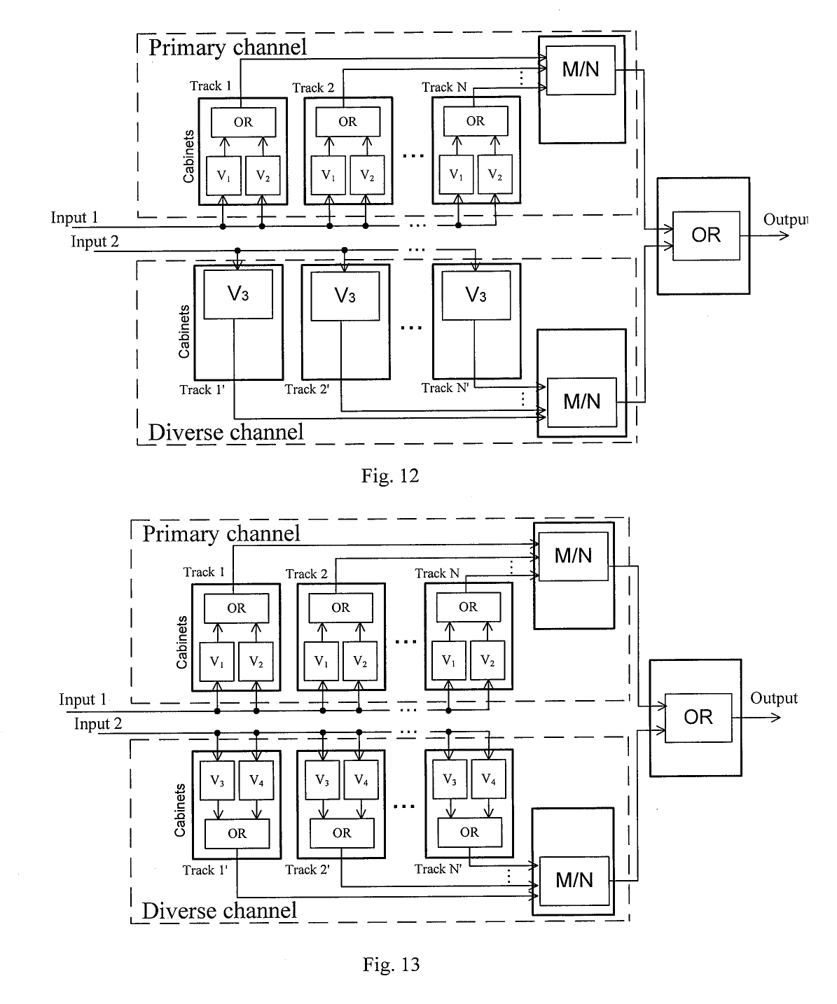

In two-channel systems internal track diversity can be implemented for tracks in one channel (FIG. 12) or for all tracks in each channel (FIG. 13). Due to different diversity types the numbers of versions can reach four V₁, V₂, V₃ and V₄. (two couples of independent versions).

Monitoring and control functions of safety critical system can be implemented by means of adjustable and scalable functions selected from the following groups:
input current and voltage signals processing;
input signals from thermocouples and resistive temperature detectors (RTD) processing;
input signals from neutron flux detectors processing;
input dry contact discrete signals processing;
input potential discrete signals of direct voltage and/or alternating voltage processing;
plant state monitoring based on received information and sending control and informational signals to actuators and I&C systems according to technological algorithms;
output current and voltage signals forming;
output potential and dry contact discrete signals forming;
actuators control;
system diagnostics;
electric and optic communication between the system components.

These functions can be realized with or enabled by Field Programmable Gates Arrays (FPGA). An FPGA is an integrated circuit designed to be configured by the customer or designer after manufacturing—hence “field programmable”.

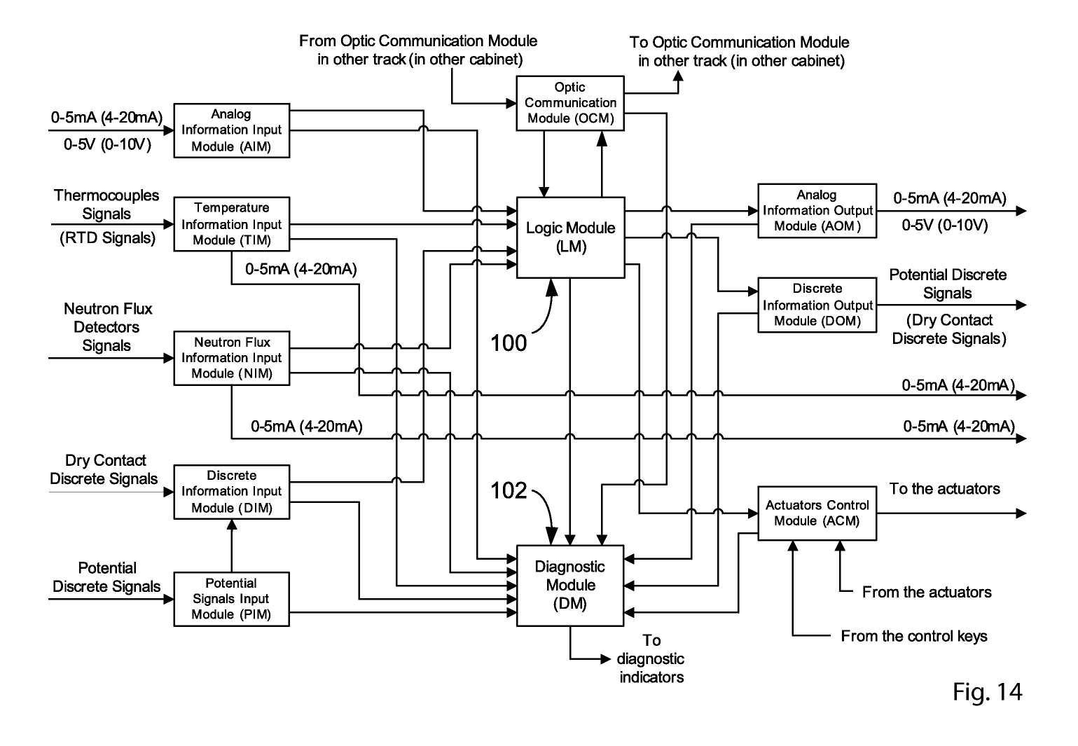

Generally speaking FIG. 14 shows platform composition and connections between modules within a Track or version V_{N} The platform includes eleven functional modules shown in Figs. from 15 to 25. In particular FIG. 14 shows a plurality of Input Modules selected from the group of Analog Information Input Module, Temperature Information Input Module, Neutron Flux Information Module, Discrete Information Input Module and Potential Signals Input Module. Moreover FIG. 14 shows a plurality of Output Modules selected from the group of Analog Information Output Module, Discrete Information Output Module, and Actuators Control Module. Each module V_{N} has a Logic Module 100 and Diagnostic Module 102. All of the modules have an FPGA except the Potential Input Signals Module. In other words the modules except the Potential Input Module is implemented by FPGA. Optionally an Optic Communications Module is utilized having an FPGA.

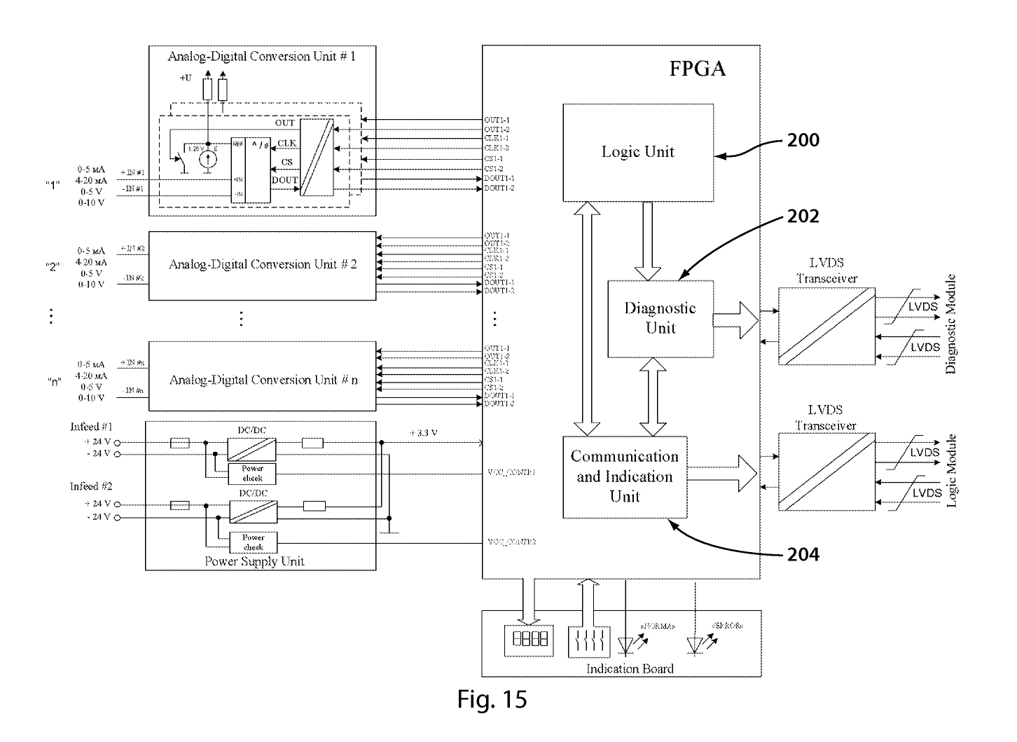

FIG. 15 shows an embodiment of an Analog Information Input Module comprising one or several Analog-Digital Conversion Units, two LVDS Transceivers, a Power Supply Unit, an Indication Board, and implemented in FPGA Logic 200, Diagnostic 202, and Communication and Indication 204 Units.

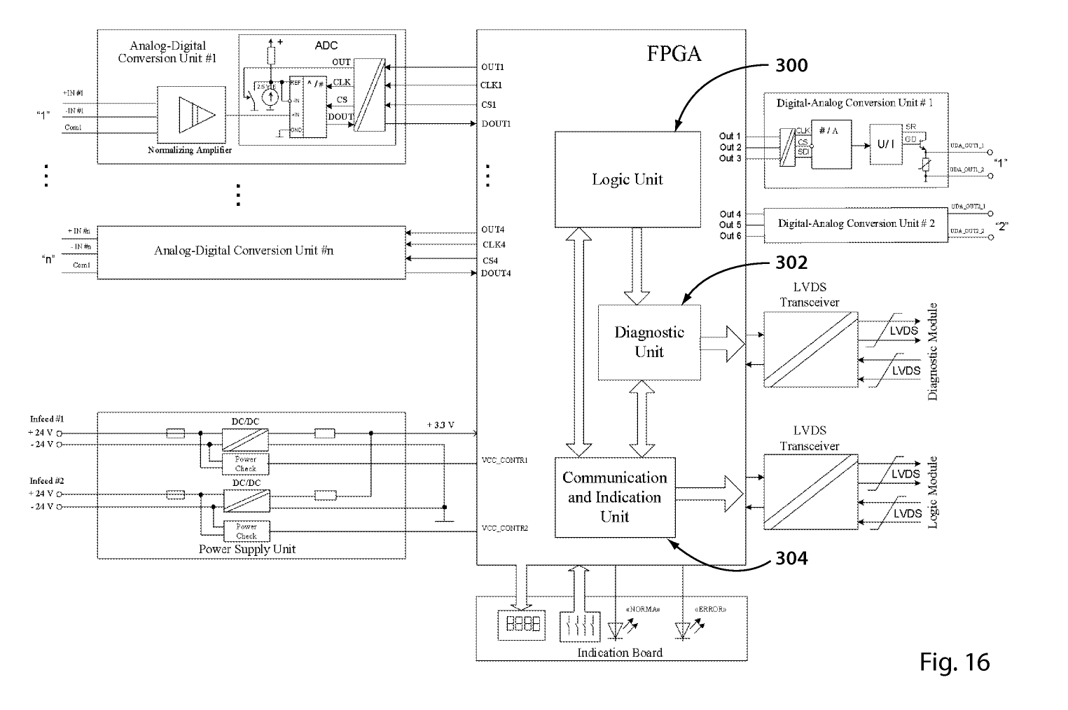

FIG. 16 shows an embodiment of a Temperature Information Input Module comprising one or several Analog-Digital Conversion Units, two Digital-Analog Conversion Units, two LVDS Transceivers, a Power Supply Unit, an Indication Board, and implemented in FPGA Logic 300, Diagnostic 302, Communication and Indication 304 Units.

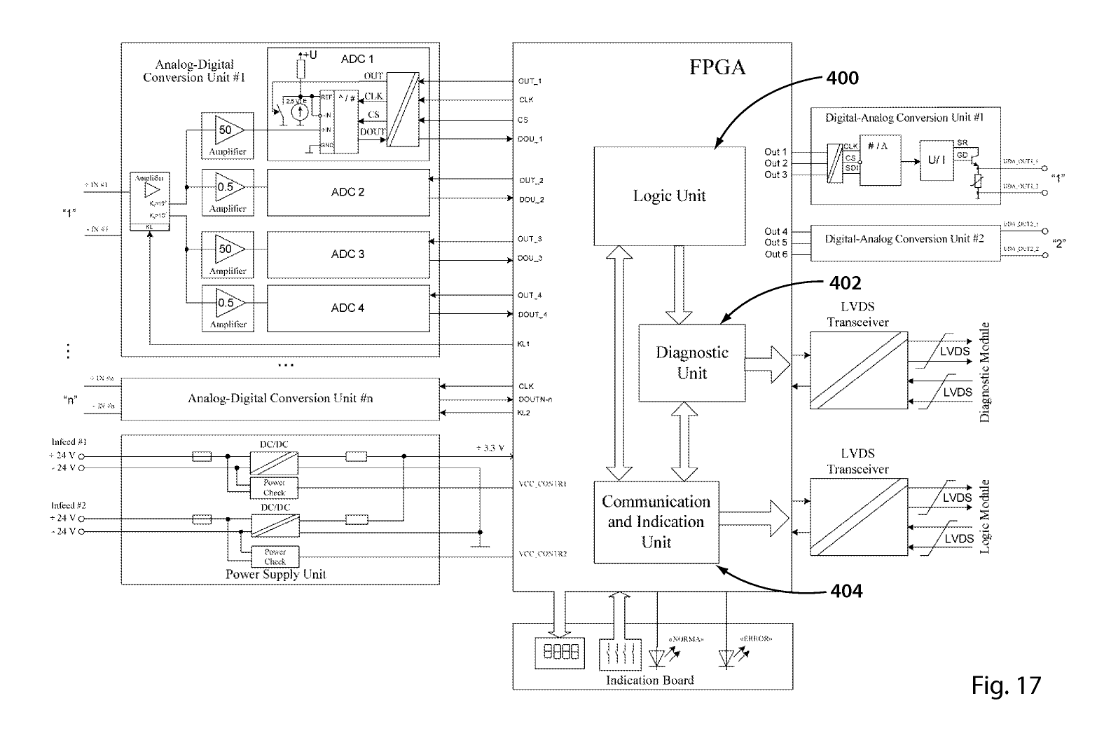

FIG. 17 shows an embodiment of a Neutron Flux Information Input Module comprising one or several Analog-Digital Conversion Units, two Digital-Analog Conversion Units, two LVDS Transceivers, a Power Supply Unit, an Indication Board, and implemented in FPGA Logic Unit 400, Diagnostic Unit 402, and Communication and Indication Unit 404.

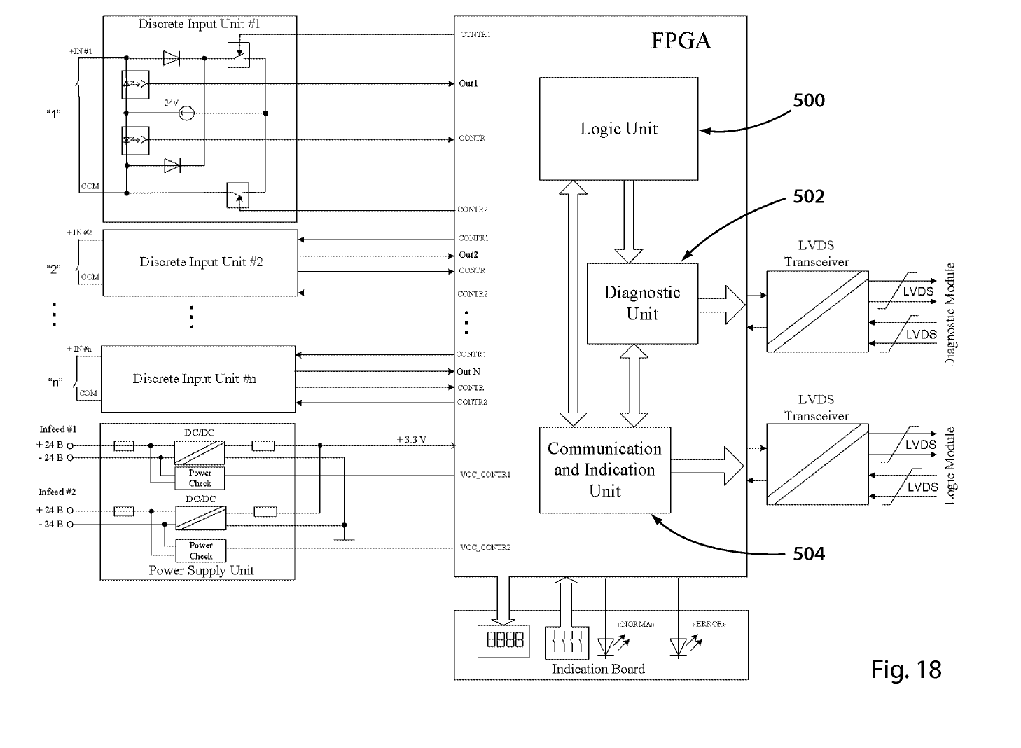

FIG. 18 shows an embodiment of a Discrete Information Input Module comprising one or several Discrete Input Units, two LVDS Transceivers, a Power Supply Unit, an Indication Board, and implemented in FPGA Logic Unit 500, Diagnostic Unit 502, Communication and Indication Unit 504.

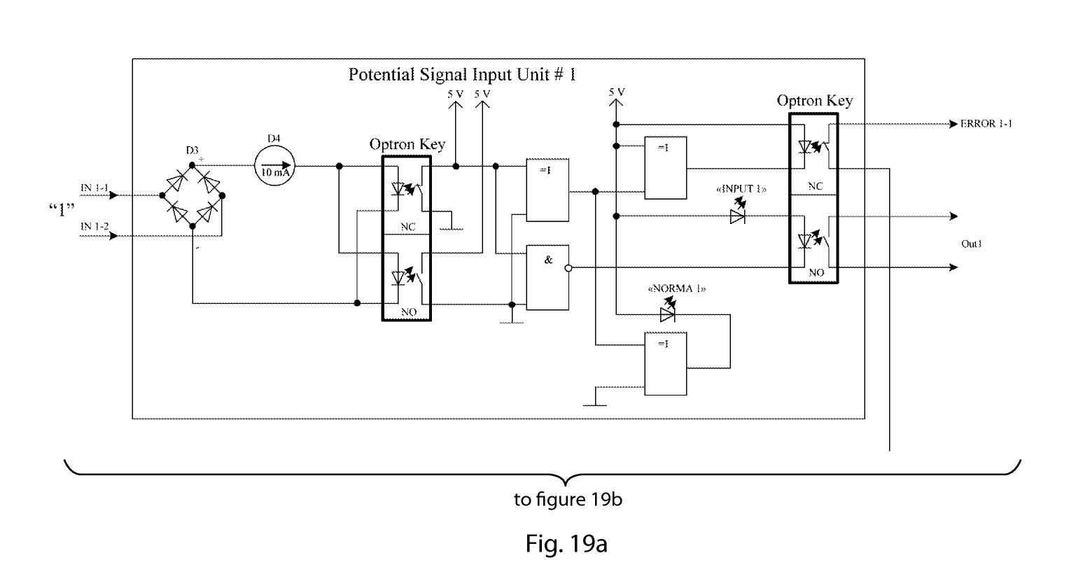

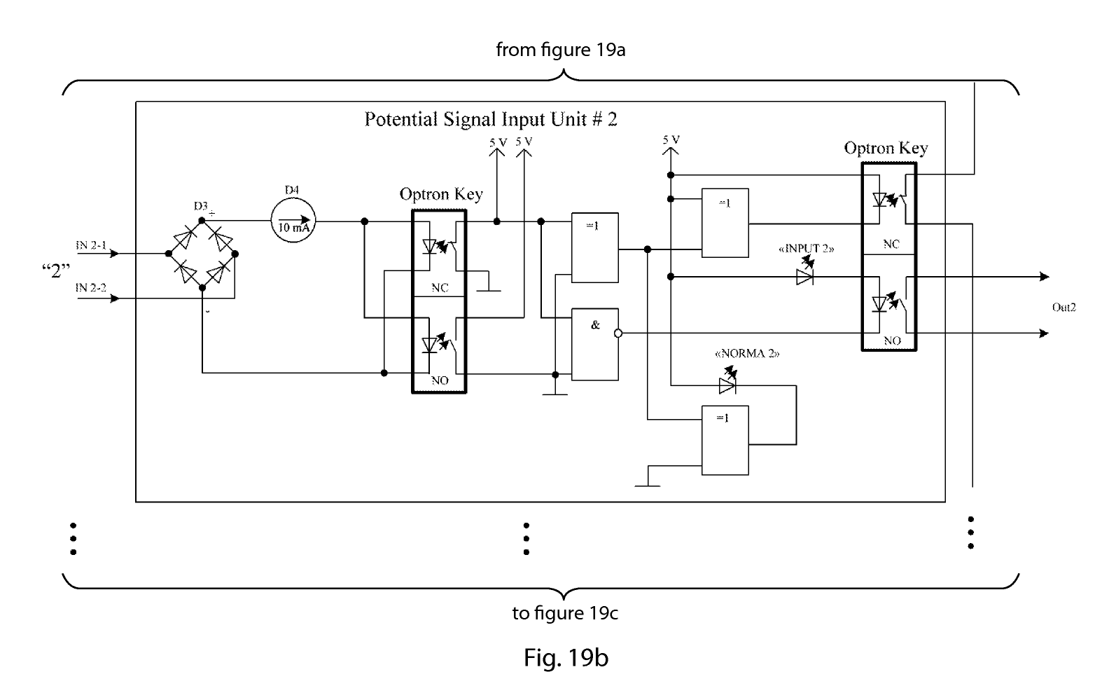

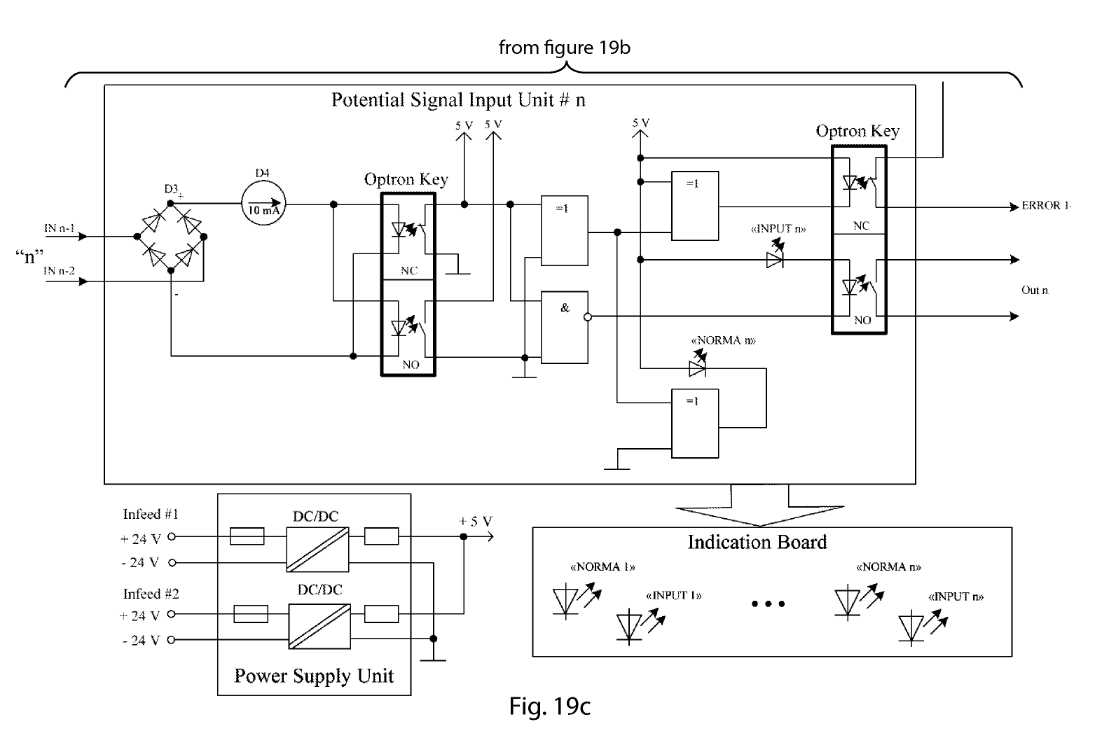

FIG. 19 shows an embodiment of a Potential Signals Input Module comprising one or several Potential Signal Input Units, a Power Supply Unit and an Indication Board.

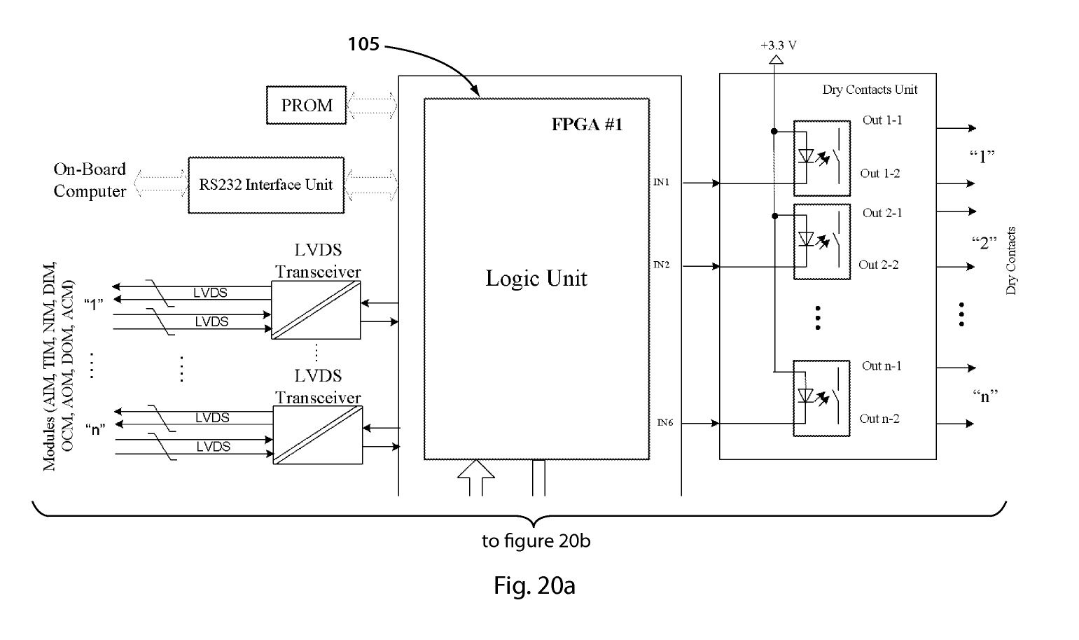

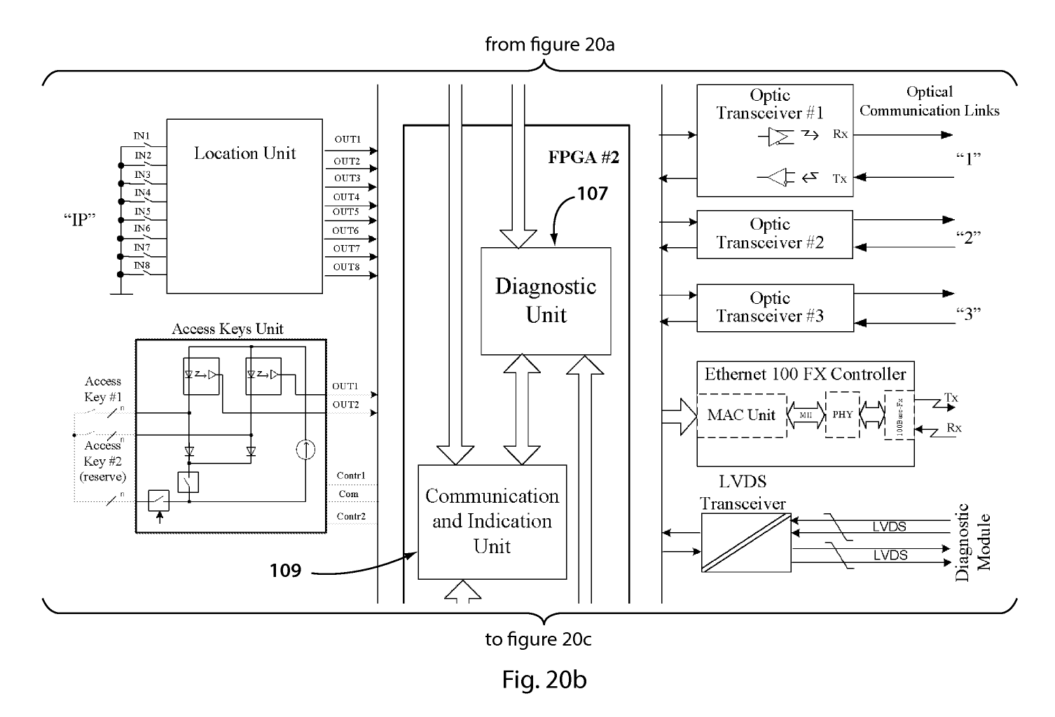

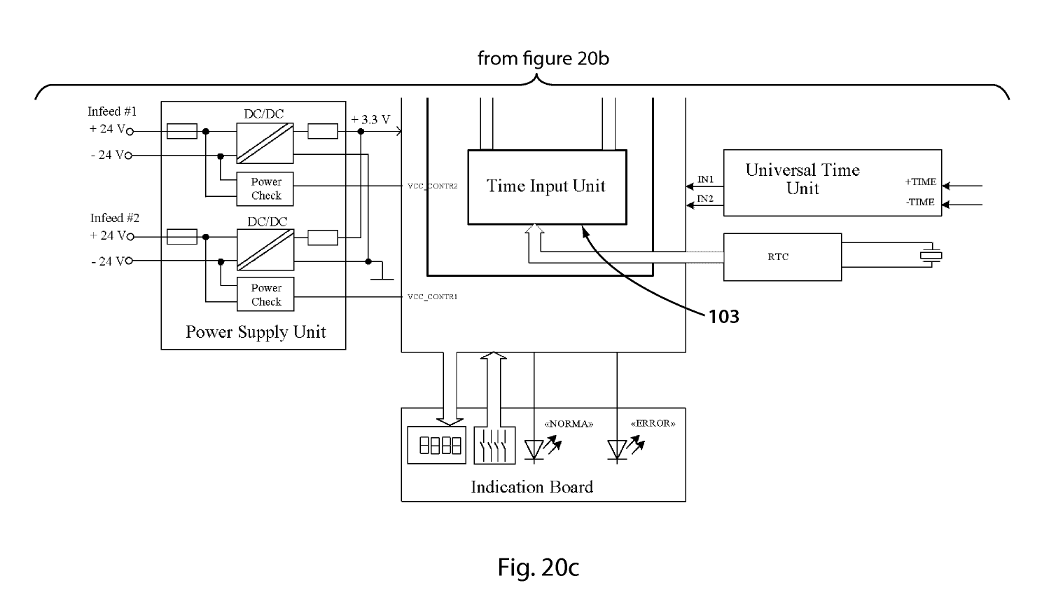

FIG. 20 shows an embodiment of a Logic Module 100 comprising several LVDS Transceivers, tree Optic Transceivers, a Location Unit, an Access Keys Unit, an Universal Time Unit, an Ethernet 100 FX Controller, a RS232 Interface Unit, a Dry Contacts Unit, a Power Supply Unit, an Indication Board, and implemented in FPGAs Time Input 103, Logic 105, Diagnostic 107, and Communication and Indication 109 Units.

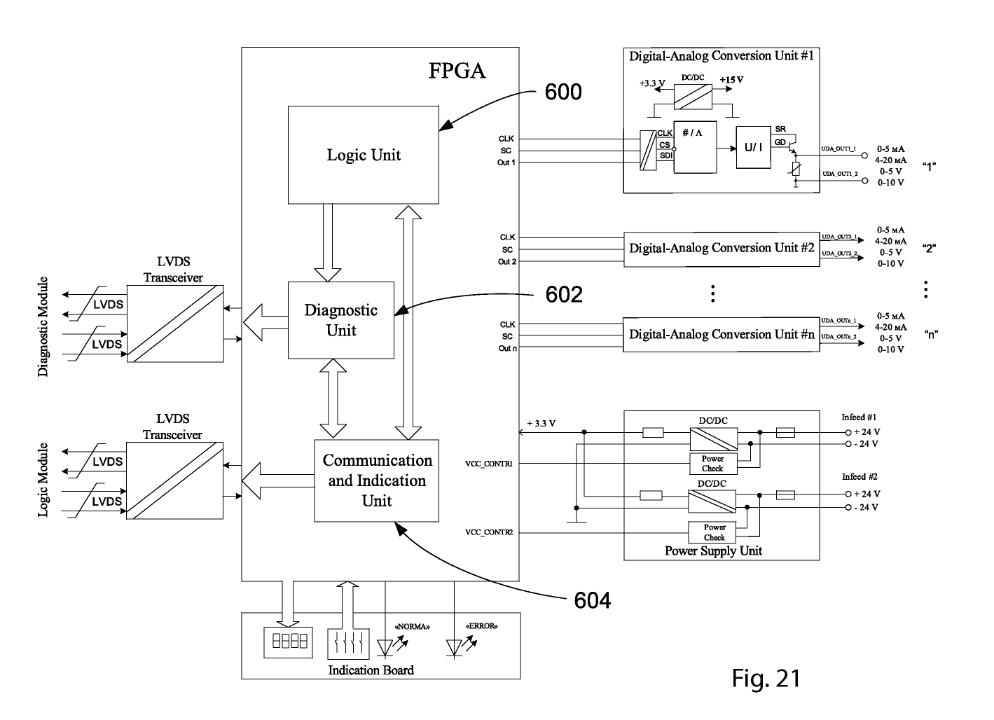

FIG. 21 shows an embodiment of an Analog Information Output Module comprising one or several Digital-Analog Conversion Units, two LVDS Transceivers, a Power Supply Unit, an Indication Board, and implemented in FPGA Logic 600, Diagnostic 602, Communication and Indication 604 Units.

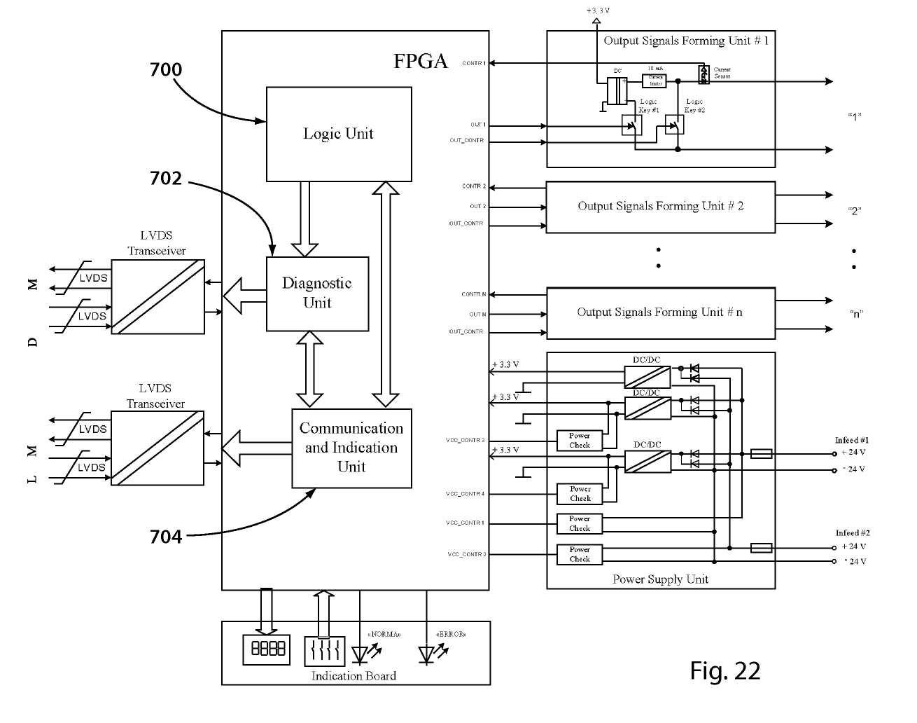

FIG. 22 shows an embodiment of a Discrete Information Output Module comprising one or several Output Signals Forming Units, two LVDS Transceivers, a Power Supply Unit, an Indication Board, and implemented in FPGA Logic 700, Diagnostic 702, and Communication and Indication 704 Units.

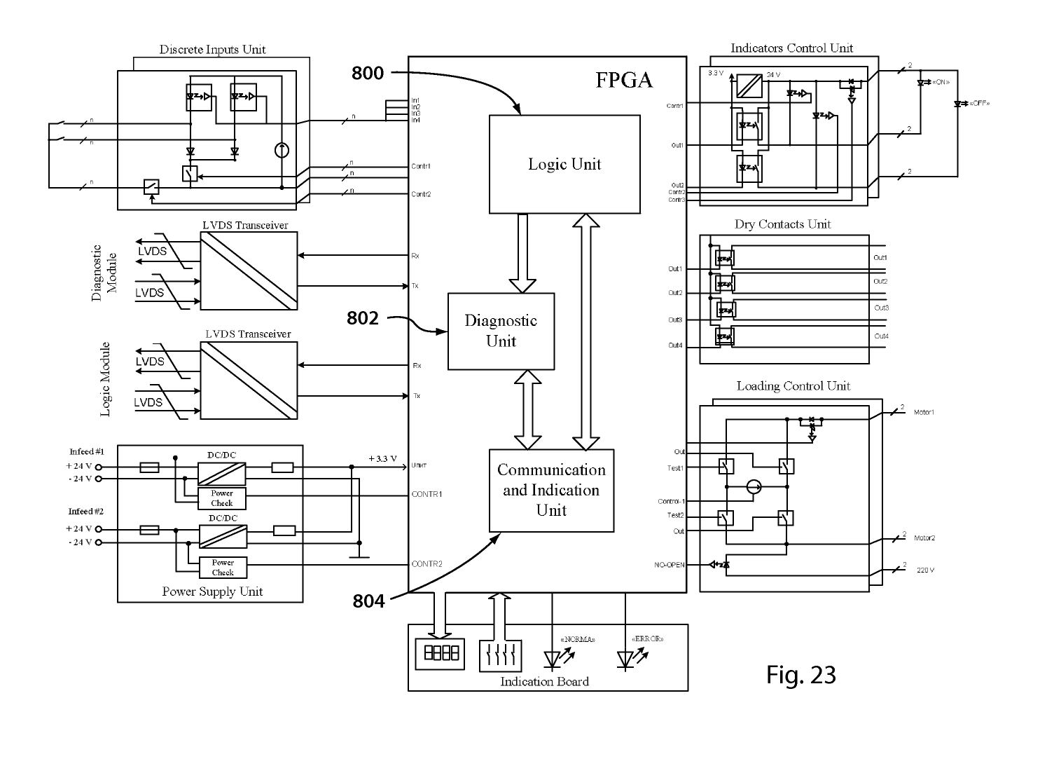

FIG. 23 shows an embodiment of an Actuators Control Module comprising one or several Discrete Inputs Units, two Indicators Control Units, two Loading Control Units, a Dry Contacts Unit, two LVDS Transceivers, a Power Supply Unit, an Indication Board, and implemented in FPGA Logic 800, Diagnostic 802, and Communication and Indication 804 Units.

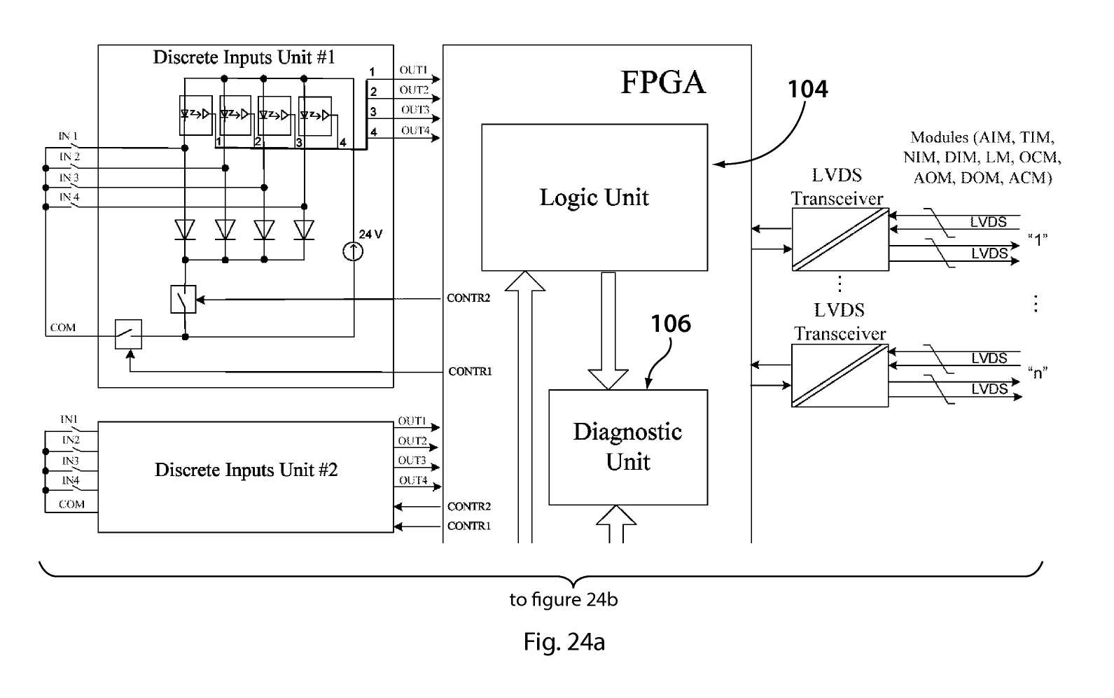

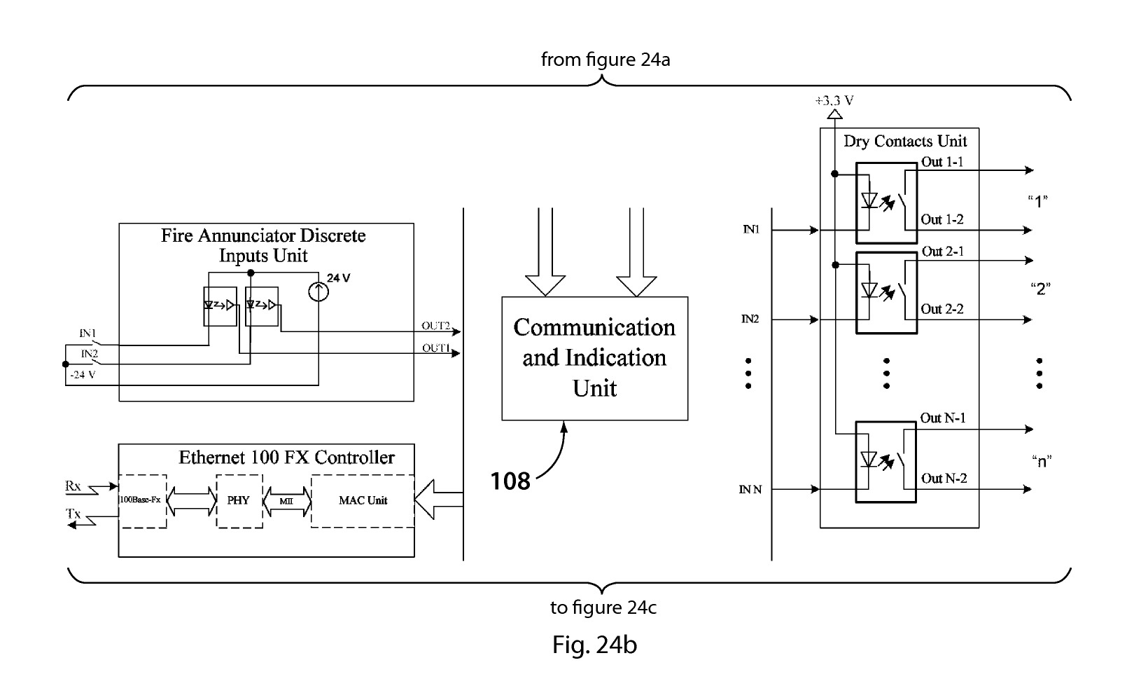

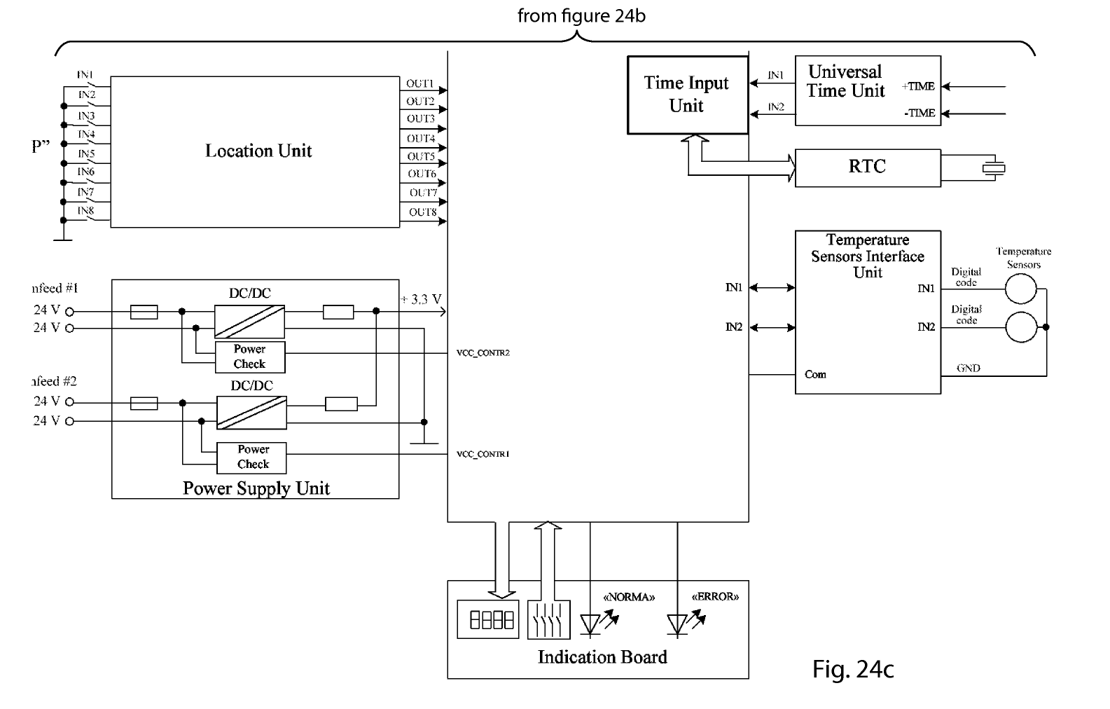

FIG. 24 shows an embodiment of a Diagnostic Module comprising two Discrete Inputs Units, a Fire Annunciator Discrete Inputs Unit, a Ethernet 100 FX Controller, a Location Unit, a Dry Contacts Unit, a Temperature Sensors Interface Unit, an Universal Time Unit, several LVDS Transceivers, a Power Supply Unit, an Indication Board, and implemented in FPGA Logic 104, Diagnostic 106, Time Input, Communication and Indication 108 Units.

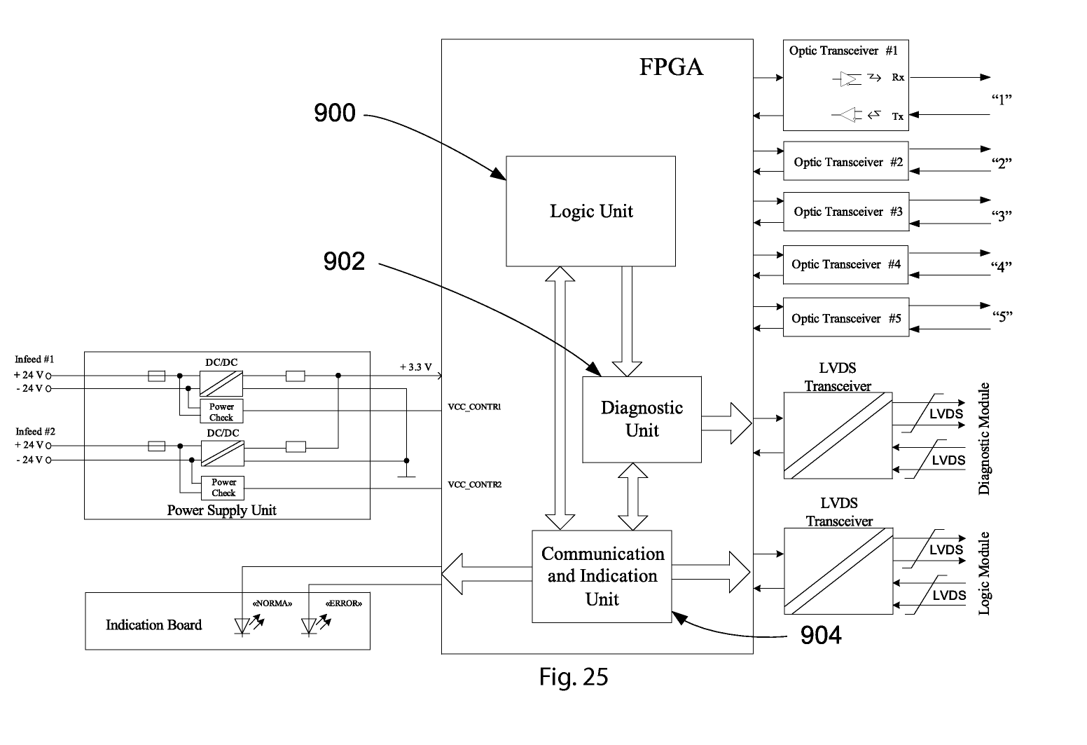

FIG. 25 shows an embodiment of an Optic Communication Module comprising five Optic Transceivers, two LVDS Transceivers, a Power Supply Unit, an Indication Board, and implemented in FPGA Logic 900, Diagnostic 902, and Communication and Indication 904 Units.

The Safety critical systems implemented on the basis of said platform receive different technological parameters, such as:
level (L);
flow rates (F);
neutron flux density (N);
pressure (P);
temperature (T);
and different dry contact discrete signals (-/-);

and perform different monitoring and control functions. More specifically these parameters comprise signals from sensors in the plant or field.

Examples of safety critical systems for nuclear power engineering are shown in Figs. from 26 to 31.

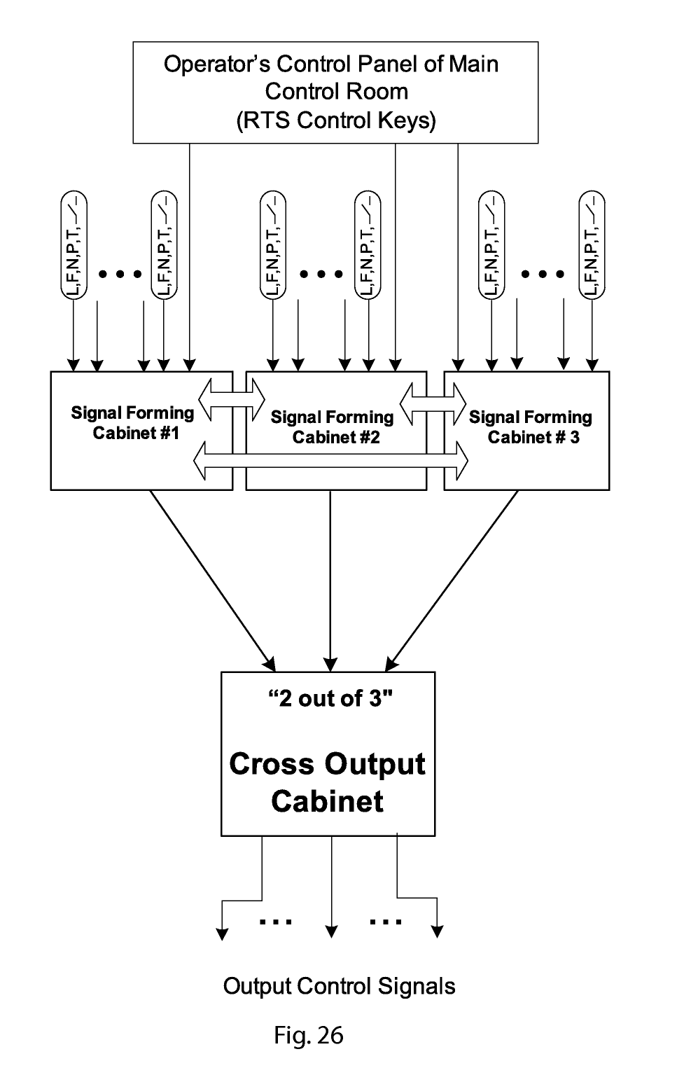

FIG. 26 shows a Reactor Trip System comprising three tracks according to block diagram in FIG. 2.

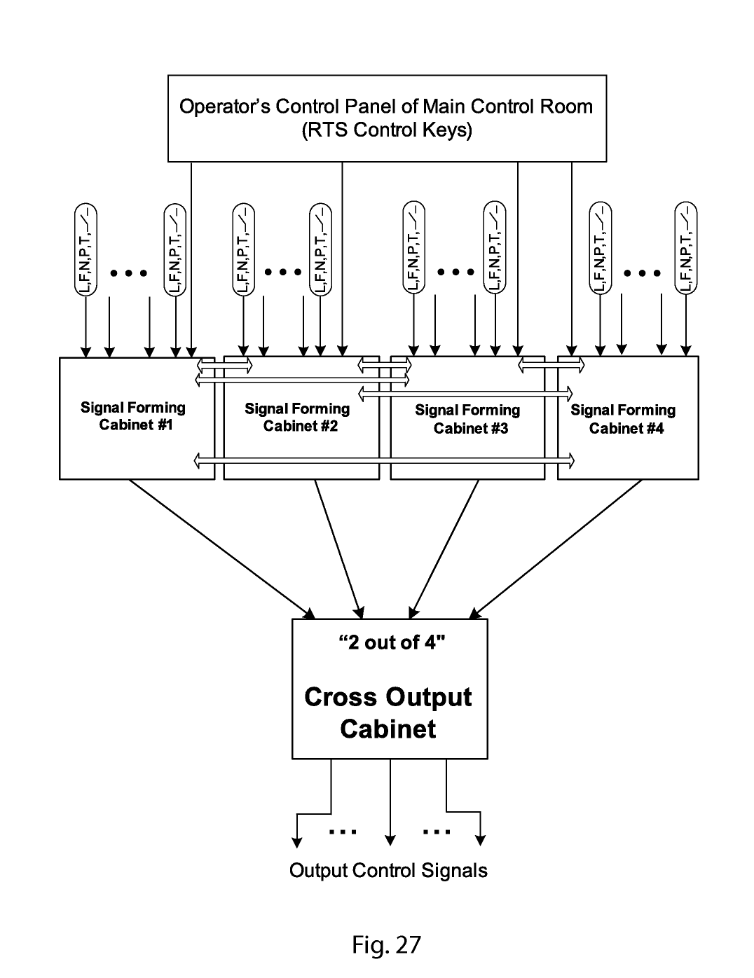

FIG. 27 shows a Reactor Trip System comprising four tracks according to block diagram in FIG. 3.

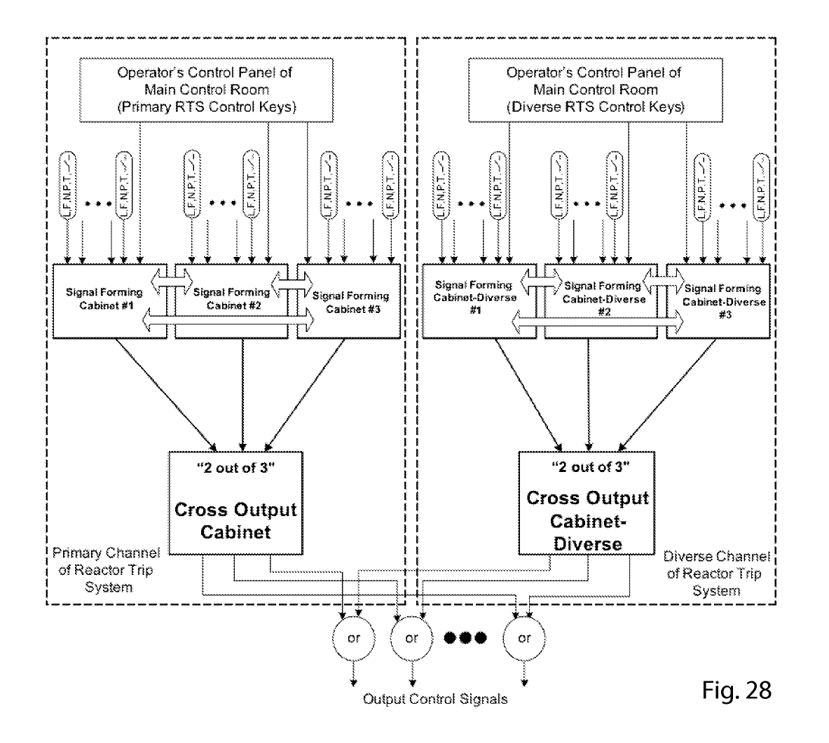

FIG. 28 shows a two-channel Reactor Trip System comprising three tracks in each channel according to block diagram in FIG. 5.

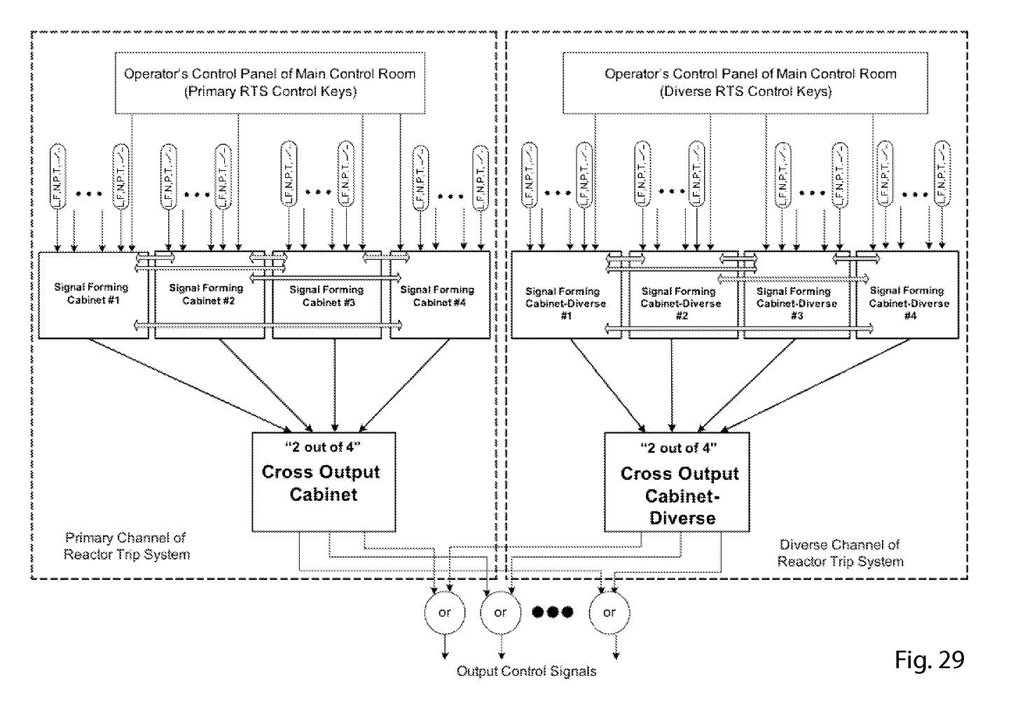

FIG. 29 shows a two-channel Reactor Trip System comprising four tracks in each channel according to block diagram in FIG. 5.

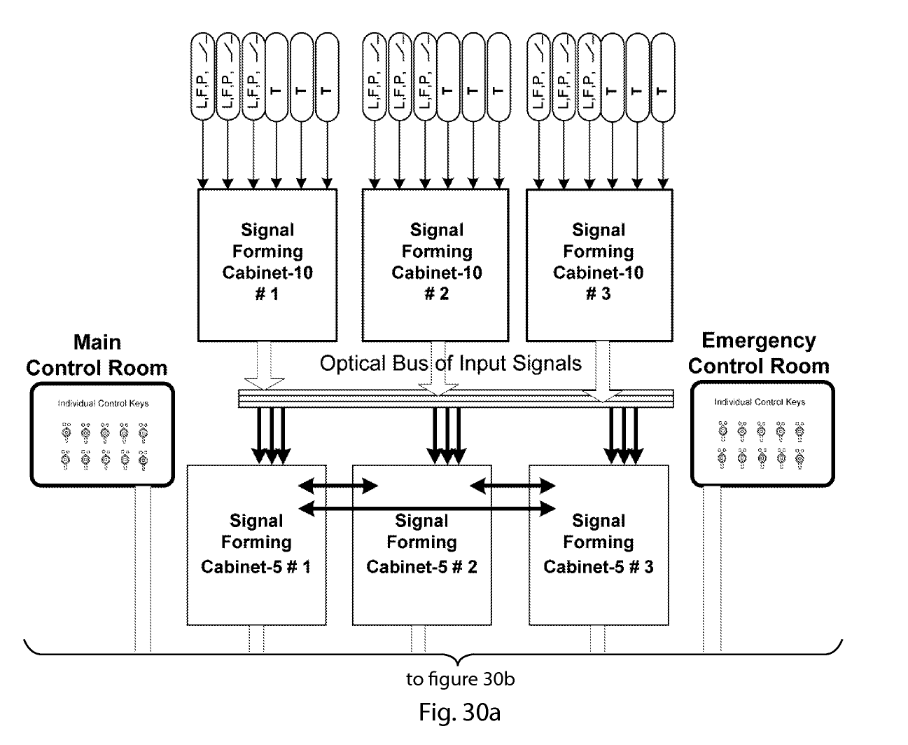

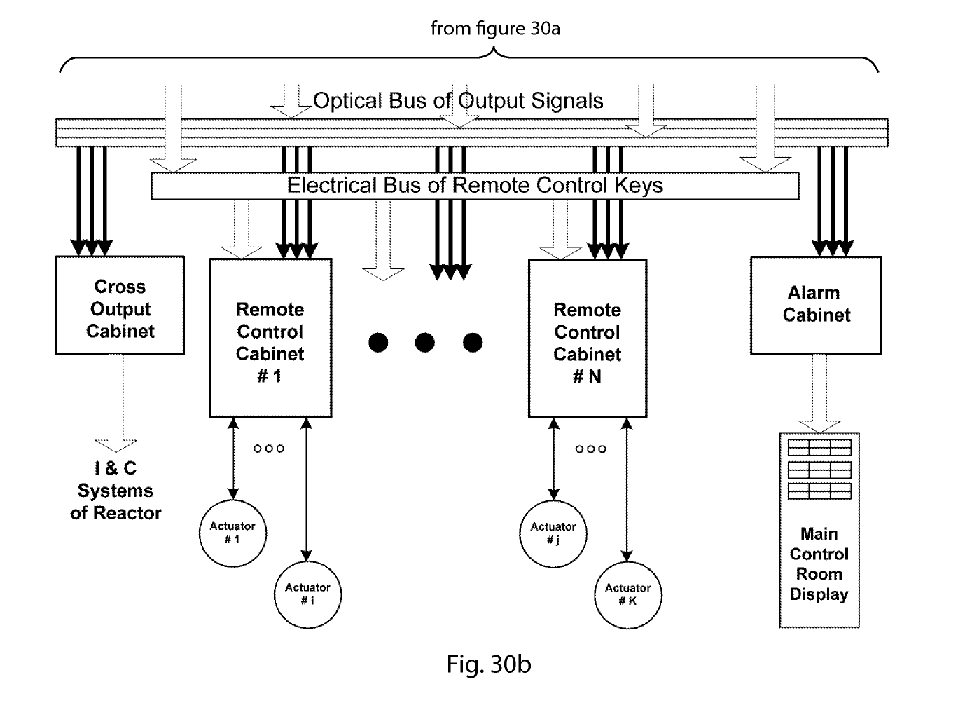

FIG. 30 shows Engineering Safety Features Actuation System comprising three tracks according to block diagram in FIG. 2.

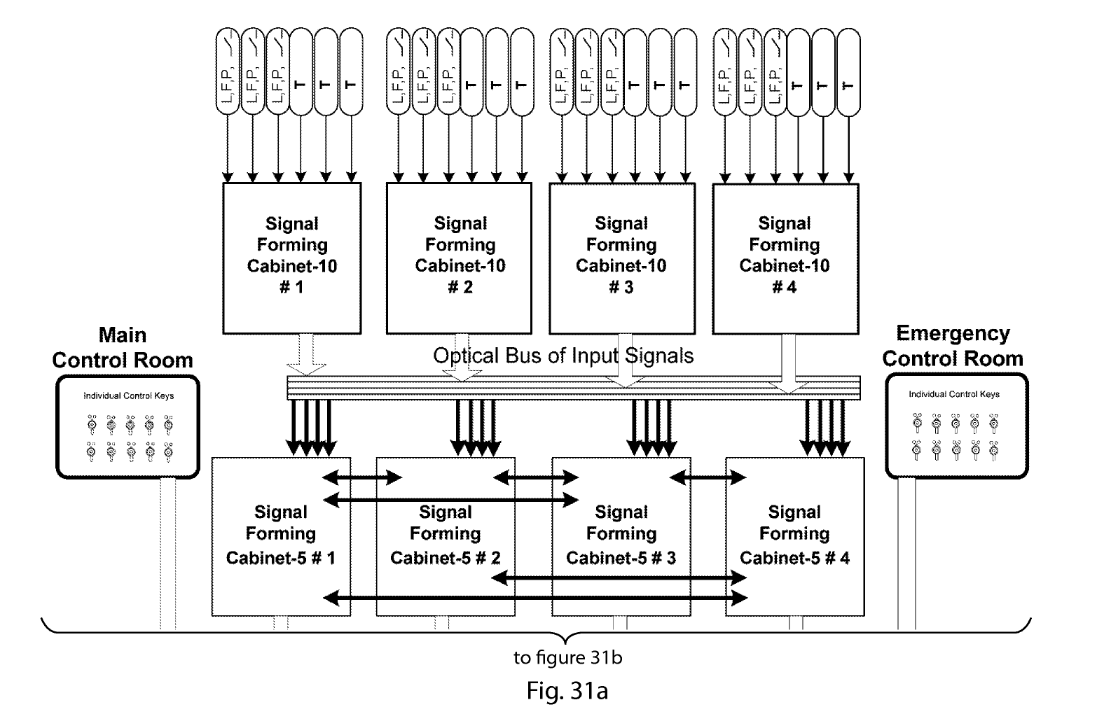

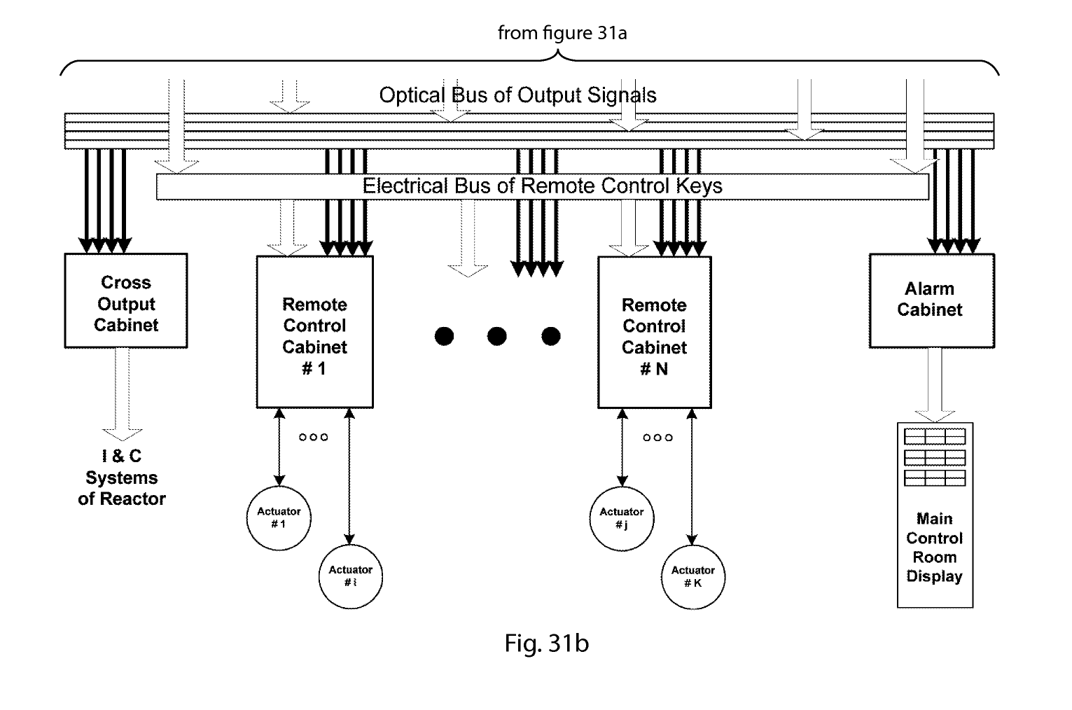

FIG. 31 shows Engineering Safety Features Actuation System comprising four tracks according to block diagram in FIG. 4.

The invention described herein relates to a method to implement safety critical systems, to perform monitoring and control functions, which:
provides functions of input current and voltage signals processing by:
   reception and galvanic isolation of current and voltage analog signals;
   transformation of input analog signals into digital code;
   filtering of received digital code;
   digital code packing for transmission and further processing;
   data exchange with subsystems that perform other functions;
   adjustment of the receive chain;
   self-diagnostics of hardware and software which perform this group functions and indication of self-diagnostic results;
provides functions of input signals from thermocouples and resistive temperature
detectors processing by:
   reception and galvanic isolation of analog signals from temperature sensors;
   transformation of input analog signals into digital code;
   filtering of received digital code;
   digital code packing for transmission and further processing;
   data exchange with subsystems that perform other functions;
   adjustment of the receive chains;
   self-diagnostics of hardware and software which perform this group functions and indication of self-diagnostic results;
provides the function of input signals from neutron flux detectors processing by:
   reception and galvanic isolation of analog current signals from ionization chambers;
   transformation of input analog signals into digital code;
   filtering of received digital code;
   digital code packing for transmission and further processing;
   data exchange with subsystems that perform other functions;
   adjustment of the receive chains;
   self-diagnostics of hardware and software which perform this group functions and indication of self-diagnostic results;
provides functions of input dry contact discrete signals processing by:
   reception and galvanic isolation of dry contact discrete signals;
   transformation of input discrete signals into digital code;
   digital code packing for transmission and further processing;
   data exchange with subsystems that perform other functions;
   self-diagnostics of hardware and software which perform this group functions and indication of self-diagnostic results;
provides functions of input potential discrete signals of direct voltage and/or
alternating voltage processing by:
   reception and galvanic isolation of discrete signals of AC and DC potential;
   forming and galvanic isolation of discrete dry contact signals;
   monitoring of input and output lines state;
provides functions of plant state monitoring based on received information and
sending control and informational signals to actuators and I&C systems according
to technological algorithms by:
   secondary filtering of digital code;
   forming of control signals based on input data according to control algorithms;
   digital code packing for control signals transmission;
   data exchange with subsystems that perform other functions;
   forming and galvanic isolation of dry contact potential signals;
   self-diagnostics of hardware and software which perform this group functions and indication of self-diagnostic results;
provides functions of output current and voltage signals forming by:
   reception of input information in digital code;
   reception of digital data packs and digital code unpacking;
   transformation of input digital code into output analog signal;
   forming and galvanic isolation of analog current and voltage signals;
   adjustment of the transmit chains;
   self-diagnostics of hardware and software which perform this group functions and indication of self-diagnostic results;
provides the function of output potential and dry contact discrete signals forming
by:
   reception of digital data packs and unpacking of digital code;
   transformation of input digital code into output discrete signals;
   forming and galvanic isolation of potential discrete signals or dry signals;
   self-diagnostics of hardware and software which perform this group functions and indication of self-diagnostic results;
provides functions of actuators control by:
   reception and galvanic isolation of discrete dry contact signals from control keys;
   reception of digital data packs and digital code unpacking;
   forming of output discrete actuator control signals;
   actuator monitoring and indication;
   self-diagnostics of hardware and software which perform this group functions and indication of self-diagnostic results;
provides system diagnostics by:
   diagnostic data acquisition on the state of subsystems that perform other functions;
   processing and allocation of received diagnostic information;
   reception and galvanic isolation of discrete dry contact signals from temperature sensors inside cabinet;
   forming and galvanic isolation of dry contact signals;
   self-diagnostics of hardware and software which perform this group functions;
provides functions of electric and optic communication between the system components by:
   data reception and transmission by digital network;
   transmission protocol control;
   self-diagnostics of hardware and software which perform this group functions and indication of self-diagnostic results.

The invention as described herein also relates to a platform which includes the following set of functional modules:

Analog Information Input Module that provides the following functions:
parallel reception of input analog signals as voltage 0-5V (0-10V) or current 0-5 (0-20) mA in several input independent and galvanically isolated lines;
parallel transformation of analog input signals into 16-bit digital code with frequency up to 100 000 times per second (signals digitization);
preliminary processing of received discrete data by low frequency filters to suppress industrial interference;
packing data received from several signal sources into integrated digital pack and its transmission by galvanically isolated LVDC (Low Voltage Differential Signaling) line to the Logic Module upon the request (the request frequency is up to 100 times per second);
preliminary adjustment of receive chains (input range, scale) to receive required metrology characteristics for module;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of generic digital pack with module state description;
transmission of diagnostic digital packs by galvanically isolated LVDS line to Diagnostic Module with frequency 100 times per second;
diagnostic results indication on LED indicators “Norma”, “Error”;
module state indication on the 4-character LED display (including upon the operator's request);
providing module elements with stable power from two galvanically isolated power transducers 24VDC/3.3VDC, each of those at the cabinet level can be powered from two independent primary power sources;

Temperature Information Input Module that provides the following functions:
parallel reception of input analog signals from temperature sensors (thermocouples and resistive temperature detector (RTD) by several input independent galvanically isolated lines;
parallel transformation of analog input signals into 16-bit digital code with frequency up to 100 000 times per second (signals digitization);
preliminary processing of received discrete data by low frequency filters to suppress industrial interference;
packing data received from several signal sources into integrated digital pack and its transmission by galvanically isolated LVDC line to the Logic Module upon the request (the request frequency is up to 100 times per second);
preliminary adjustment of receive chains (input range, scale) to receive required metrology characteristics for module;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of generic digital pack with module state description;
transmission of diagnostic digital packs by galvanically isolated LVDS line to Diagnostic Module with frequency 100 times per second;
diagnostic results indication on LED indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Neutron Flux Information Input Module that provides the following functions:
parallel reception of input analog signals as ionization chambers current in the range from 1*10E-10 to 1*10E-3 by several input independent galvanically isolated lines;
parallel transformation of analog input signals into 16-bit digital code with frequency up to 100 000 times per second (signals digitization);
preliminary processing of received discrete data by low frequency filters to suppress industrial interference;
packing data received from several signal sources into integrated digital pack and its transmission by galvanically isolated LVDC line to the Logic Module upon the request (the request frequency is up to 100 times per second);
preliminary adjustment of receive chains (input range, scale) to receive required metrology characteristics for module;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of general digital pack with module state description;
transmission of diagnostic digital packs by galvanically isolated LVDS line to Diagnostic Module with frequency 100 times per second;
diagnostic results indication on LED indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Discrete Information Input Module that provides the following functions:
parallel reception of input dry contact discrete signals by several input independent galvanically isolated lines;
parallel transformation of discrete input signals into digital code with frequency up to 100 000 times per second;
packing data received from several signal sources into integrated digital pack and its transmission by galvanically isolated LVDC line to the Logic Module upon the request (the request frequency is up to 100 times per second);
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of generic digital pack with module state description;
transmission of diagnostic digital packs by galvanically isolated LVDS line to Diagnostic Module with frequency 100 times per second;
diagnostic results indication on LED indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Potential Signals Input Module that provides the following functions:
parallel reception of input discrete signals of AC and DC potential (from 24V to 240 V) by several input independent galvanically isolated lines;
parallel forming of equivalent output discrete dry contact signals by output independent galvanically isolated lines with switching capacity 48V (0,1A) (the number of output lines equals to the number of input lines);
monitoring of input potential on inputs and LED indication on the indication board;
monitoring of output state, validity of transformation in every line and LED indication on the indication board;
monitoring of being a module in normal position (thread checking);
providing module elements with stable power from two galvanically isolated power converters 24 VDC/5 VDC, each of those converters at the cabinet level can be powered from two different independent primary power sources;

Logic Module that provides the following functions:
reception of digital data packs by galvanically isolated LVDS lines from input signal modules (AIM, TIM, NIM, DIM) and Actuators Control Module (ACM);
secondary processing of discrete digital data by low frequency filters to suppress industrial interference;
input data processing and control signals forming according to protection algorithms, interlocks and alarms;
packing of control signals into digital code and digital data packs transmission to output signals modules (AOM, DOM, ACM) and Optic Communication Module (OCM) with frequency 100 times per second by independent galvanically isolated LVDS lines;
forming of data flow and providing correspondent protocols of three optic communication channels;
parallel forming of output discrete dry contact signals on 16 input independent galvanically isolated lines;
providing procedure of authorized access to On-Board Computer based on the state analysis of mechanical key on the cabinet front panel;
providing connection according to communication protocol between RS-232 and cabinet On-Board Computer;
module IP-address forming based on analysis of jumpers state on chassis motherboard where module is installed;
data flow forming and providing optic communication channel protocol according to protocol Ethernet 100 Base-FX;
forming of module internal system time and its synchronization by external universal time signals with external source available;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of general digital pack with module state description;
transmission of diagnostic digital packs by galvanically isolated LVDS line to Diagnostic Module with frequency 100 times per second;
diagnostic results indication on LED indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Analog Information Output Module that provides the following functions:
reception of data packs from Logic Module with frequency 100 times per second by LVDS bus and unpacking of 16-bit digital code modules;
parallel transformation of 16-bit digital codes into equivalent analog signals;
parallel forming of output analog voltage signals 0-5(0-10) V or current signals 0-5(0-20) mA on several input independent galvanically isolated lines;
preliminary adjustment of transmit chains (output range, scale) to receive required metrology characteristics for a module;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of general digital pack with module state description;
transmission of diagnostic digital packs by galvanically isolated LVDS line to Diagnostic Module with frequency 100 times per second;
diagnostic results indication on LED indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Discrete Information Output Module that provides the following functions:
reception of data packs from Logic Module with frequency 100 times per second by LVDS bus and digital code unpacking;
parallel transformation of digital codes into equivalent output discrete signals;
parallel forming of output discrete signals of 0-24 VDC (with load current up to 10 mA) or dry contacts on several input independent galvanically isolated lines;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of general digital pack with module state description;
transmission of diagnostic digital packs by galvanically isolated LVDS line to Diagnostic Module with frequency 100 times per second;
diagnostic results indication on LED indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Actuators Control Module that provides the following functions:
parallel reception of input discrete dry contact signals on several 4-channel input independent galvanically isolated lines from control keys with continuous monitoring;
data packs reception from Logic Module with frequency 100 times per second by LVDS bus and digital code unpacking;
forming of output discrete actuator control signals as two independent galvanically isolated closing dry contacts with switching capacity 220 VDC (or VAC), 1A;
parallel reception of input discrete signals of actuator monitoring (“Not Open”) by two lines galvanically connected with control signal indication circuits and forming on their basis discrete internal signals by galvanic isolation;
parallel forming of discrete control signals for LED indication “ON”/“OFF” as potential output signals on galvanically isolated lines;
parallel forming of output dry contact signals on four galvanically isolated lines (distribute of actuator state information);
digital pack transmission of actuator monitoring by galvanically isolated LVDS line into Logic Module with frequency 100 times per second;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of generic digital pack with module state description;
transmission of diagnostic digital packs by galvanically isolated LVDS line to Diagnostic Module with frequency 100 times per second;
diagnostic results indication on LCD indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Diagnostic Module that provides the following functions:
reception of diagnostic digital packs by galvanically isolated LVDS lines with frequency 100 times per second;
forming and transmission of diagnostic information general pack to archive and information allocation system;
parallel reception of input discrete dry contact signals by eight input independent galvanically isolated lines (including from open door sensors);
parallel reception from two fire enunciators of input discrete dry contact signals by independent galvanically isolated lines;
parallel reception of input digital signals from two independent temperature sensors by galvanically isolated lines (temperature sensors are installed inside cabinet);
parallel forming of output discrete dry contact signals on several output independent galvanically isolated lines;
module IP-address forming based on analysis of jumpers state on chassis motherboard where module is installed;
data flow forming and providing optic communication channel protocol according to protocol Ethernet 100 Base-FX;
forming of module internal system time and its synchronization by external universal time signals with external source available;
preliminary forming of the configuration item record to provide identification in the configuration control system;
module hardware continuous diagnostics by fault detection internal algorithms;
continuous checksum analysis of module internal program to verify its integrity;
FPGA electronic design checksum analysis in power up time to verify integrity;
forming of general digital pack with module state description;
diagnostic results indication on LCD indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources;

Optic Communication Module that provides the following functions:
reception of packed digital data packs from Logic Module with the speed 100 times per second by galvanically isolated LVDS lines, their unpacking and distribution to transmit to recipients by optic link;
reception and transmission of data by optic communication links;
reception of data by optic communication links and transmission of formed and packed digital data packs into Logic Module by independent galvanically isolated LVDS line with the speed 100 times per second;
preliminary forming of the configuration item record to provide identification in the configuration control system;
module hardware continuous diagnostics by fault detection internal algorithms;
forming of general digital pack with module state description;
transmission of diagnostic digital packs by galvanically isolated LVDS line to Diagnostic Module with frequency 100 times per second;
diagnostic results indication on LCD indicators “Norma”, “Error”;
module state indication on the 4-character LED display (including upon the operator's request);
providing module elements with stable power from two galvanically isolated power transducers 24 VDC/3.3 VDC, each of those at the cabinet level can be powered from two independent primary power sources.

What is claimed is:

1. A method of monitoring and controlling plant operations, which receive input signals from sensors monitoring parameters of plant operation to generate output signals to actuators, comprising;
reducing the input signals to a selected group of input functions;
reducing the output signals to a selected group of output functions;
processing the input signals using FPGA to generate the output signals.

2. A method as claimed in claim 1 further comprising implementing said functions within one track or within many redundant tracks.

3. A method to implement safety critical systems, to perform monitoring and control functions, comprising:
receiving information on the controlled parameters of sensors and other instrumentation and control (I&C) systems,
processing this information and sending control and informational signals to actuators and other I&C systems; according to technological algorithms;
reducing said l&C functions into groups of functions according to:
input current and voltage signals processing;
input signals from thermocouples and resistive temperature detectors processing;
input signals from neutron flux detectors processing;
input dry contact discrete signals processing;
input potential discrete signals of direct voltage and/or alternating voltage processing;
plant state monitoring based on received information and sending control and informational signals to actuators and I&C systems according to technological algorithms;
output current and voltage signals forming;
output potential and dry contact discrete signals forming;
actuators control;
system diagnostics;
electric and optic communication between the system components;
implementing of the group of functions using Field Programmable Gate Arrays (FPGA);
implementing said group of functions within one track or within many redundant tracks.

4. A method as claimed in claim 3 wherein said implementing of said functions of redundant tracks and channels comprise the following diversity types:
diversity based on using FPGA chips from different vendors;
diversity based on using FPGA chips with different implemented technologies (production and programming);
diversity based on using different languages for electronic FPGA project description;
diversity based on using different tools for electronic design of FPGA;
diversity based on using different configuration to the development of electronic design of FPGA;
diversity based on using different sources of information on controllable parameters.

5. The method of claim 4, which provides the functions of:
input current and voltage signals processing;
input signals from thermocouples and resistive temperature;
input signals from neutron flux detectors processing;
input dry contact discrete signals processing;
input potential discrete signals of direct voltage and/or
alternating voltage processing;
plant state monitoring based on received information and
sending control and informational signals to actuators and l&C systems according to technological algorithms;
output current and voltage signals forming;
output potential and dry contact discrete signals forming;
actuators control by;
system diagnostics; and
electric and optic communication between the system components.

6. The method of claim 5 further comprising selecting configurations of multi-version systems from the group consisting of:
three (or four) tracks with diverse implementations and separated location in tree (or four) cabinets, voting logic “2-out-of-3” (or “2-out-of-4”) for output implemented in a separate cabinet;
three (or four) tracks with diverse implementations and separated location in tree (or four) cabinets, voting logic “2-out-of-3” (or “2-out-of-4”) implemented in each track and logic OR for output implemented in a separate cabinet;
three (or four) identical tracks with two-version implementations (inside diversity) and separated location in three (or four) cabinets, logic OR implemented for versions in each track and voting logic “2-out-of-3” (or “2-out-of-4”) for output implemented in a separate cabinet;
different two four-track (or three-track) channels where tracks are located in different cabinets with voting logic implemented in a separate cabinet; for outputs of channels the voting logic is implemented according to the scheme OR or other scheme which is defined by the system's functionality;
different two four-track (or three-track) channels where tracks are located in different cabinets with voting logic implemented for each track in the same cabinet; for outputs of channels the voting logic is implemented according to the scheme OR or other scheme which is defined by the system's functionality;
different two four-track (or three-track) channels, where cabinet contains two diverse tracks from different channels with voting logic implemented in separate cabinets; for outputs of channels voting logic is implemented according to the scheme OR or other scheme which is defined by system's functionality;
different two four-track (or three-track) channels, where cabinet contains two diverse tracks from different channels with voting logic implemented for each track in the same cabinet; for outputs of channels voting logic is implemented according to the scheme OR or other scheme which is defined by system's functionality.

7. A platform for monitoring and controlling plant operations, which receive input signals from sensors monitoring parameters of plant operation to generate output signals to actuators, which includes the following set of functional modules:
Analog Information Input Module;
Temperature Information Input Module;
Neutron Flux Information Input Module;
Discrete Information Input Module;
Potential Signals Input Module;
Logic Module that has an FPGA electronic design;
Analog Information Output Module;
Discrete Information Output Module;
Actuators Control Module;
Diagnostic Module;
Optic Communication Module.

8. The platform of claim 7, wherein said Analog Information Input Module comprises one or several Analog-Digital Conversion Units, two LVDS Transceivers, a Power Supply Unit, an Indication Board, and implemented in FPGA Logic, Diagnostic, Communication and Indication Units.

9. The platform of claim 7, wherein said Temperature Information Input Module comprises one or several Analog-Digital Conversion Units, two Digital-Analog Conversion Units, two LVDS Transceivers, a Power Supply Unit, an Indication Board, and implemented in FPGA Logic, Diagnostic, Communication and Indication Units.

10. The platform of claim 7, where Neutron Flux Information Input Module comprises one or several Analog-Digital Conversion Units, two Digital-Analog Conversion Units, two LVDS Transceivers, a Power Supply Unit, an Indication Board, and implemented in FPGA Logic, Diagnostic, Communication and Indication Units.

11. The platform of claim 7, wherein said Discrete Information Input Module comprises one or several Discrete Input Units, two LVDS Transceivers, a Power Supply Unit, an Indication Board, and implemented in FPGA Logic, Diagnostic, Communication and Indication Units.

12. The platform of claim 7, wherein said Potential Signals Input Module comprises one or several Potential Signal Input Units, a Power Supply Unit and an Indication Board.

13. The platform of claim 7, where Logic Module comprises several LVDS Transceivers, three Optic Transceivers, a Location Unit, an Access Keys Unit, an Universal Time Unit, an Ethernet 100 FX Controller, a RS232 Interface Unit, a Dry Contacts Unit, a Power Supply Unit, an Indication Board, and implemented in FPGAs Time Input, Logic, Diagnostic, Communication and Indication Units.

14. The platform of claim 7, where Analog Information Output Module comprises one or several Digital-Analog Conversion Units, two LVDS Transceivers, a Power Supply Unit, an Indication Board, and implemented in FPGA Logic, Diagnostic, Communication and Indication Units.

15. The platform of claim 7, wherein said Discrete Information Output Module comprises one or several Output Signals Forming Units, two LVDS Transceivers, a Power Supply Unit, an Indication Board, and implemented in FPGA Logic, Diagnostic, Communication and Indication Units.

16. The platform of claim 7, where Actuators Control Module comprises one or several Discrete Inputs Units, two Indicators Control Units, two Loading Control Units, a Dry Contacts Unit, two LVDS Transceivers, a Power Supply Unit, an Indication Board, and implemented in FPGA Logic, Diagnostic, Communication and Indication Units.

17. The platform of claim 7, where Diagnostic Module comprises two Discrete Inputs Units, a Fire Annunciator Discrete Inputs Unit, a Ethernet 100 FX Controller, a Location Unit, a Dry Contacts Unit, a Temperature Sensors Interface Unit, an Universal Time Unit, several LVDS Transceivers, a Power Supply Unit, an Indication Board, and implemented in FPGA Logic, Diagnostic, Time Input, Communication and Indication Units.

18. The platform of claim 7, where Optic Communication Module comprises five Optic Transceivers, two LVDS Transceivers, a Power Supply Unit, an Indication Board, and implemented in FPGA Logic, Diagnostic, Communication and Indication Units.

19. Reactor Trip System (RTS), which
performs the following functions:
storage of setpoints and conditions of reactor trip initiation;
automatic monitoring of technological parameters and equipment states;
forming of reactor trip signals in case of breaking of set points and conditions;
data exchange with I&C systems of reactor;
indication of technological parameters, reactor trip information and alarm signals at Main Control Room and Emergency Control Room;
data archiving, registration and visualization;
self-diagnostic and visualization of diagnostic data;
has four or three tracks;
includes Signal Forming Cabinets (SFC) comprising the following platform modules (one or several of each type);
Analog Information Input Module;
Temperature Information Input Module;
Neutron Flux Information Input Module;
Discrete Information Input Module;
Potential Signals Input Module;
Logic Module;
Discrete Information Output Module;
Diagnostic Module;
Optic Communication Module;
includes Cross Output Cabinet (COC) comprising the following platform modules (one or several of each type);
Logic Module;
Analog Information Output Module;
Discrete Information Output Module;
Diagnostic Module;
Optic Communication Module.

20. The Reactor Trip System of claim 19 which includes two channels (primary and diverse) with four or three tracks in each channel and forming output control signals by the scheme OR out of outputs from channels.

21. Engineering Safety Features Actuation System (ESFAS) comprising:
automatic monitoring of technological parameters and equipment states;
forming of interlock signals for automatic control of actuators;
remote control of actuators;
indication of technological parameters and alarm signals at Main Control Room and Emergency Control Room;
data exchange with l&C systems of reactor;
data archiving, registration and visualization;
self-diagnostic and visualization of diagnostic data;
has four or three tracks; includes Signal Forming Cabinets-10 (SFC-10) with the following platform modules (one or several of each type);
Analog Information Input Module;
Temperature Information Input Module;
Discrete Information Input Module;
Potential Signals Input Module;
Logic Module;
Diagnostic Module;
Optic Communication Module;
includes Signal Forming Cabinets-5 (SFC-5) having the following platform modules (one or several of each type);
Logic Module;
Analog Information Output Module;
Discrete Information Output Module;
Diagnostic Module;
Optic Communication Module;
includes Cross Output Cabinet (COC) comprising the following platform modules (one or several of each type) according to claim 4:
Logic Module;
Analog Information Output Module;
Discrete Information Output Module;
Diagnostic Module;
Optic Communication Module;
includes Remote Control Cabinets (RCC) comprising the following platform modules (one or several of each type) according to claim 4:
Logic Module;
Actuators Control Module;
Diagnostic Module;
Optic Communication Module;
And includes Alarm Cabinet (AC) comprising the following platform modules (one or several of each type) according to claim 4:
Discrete Information Input Module;
Logic Module;
Discrete Information Output Module;
Diagnostic Module;
Optic Communication Module.
